(19) United States
(12) Patent Application Publication
(10) Pub. No.: US 2011/0078138 A1
(43) Pub. Date: Mar. 31, 2011

(54) System for Matching Property Characteristics or Desired Property Characteristics to Real Estate Agent Experience

(76) Inventor: Jonathan Cardella, San Francisco, CA (US)

(21) Appl. No.: 12/849,612

(22) Filed: Aug. 3, 2010

Related U.S. Application Data
(60) Provisional application No. 61/230,979, filed on Aug. 3, 2009.
(60) Provisional application No. 61/230,981, filed on Aug. 3, 2009.
(60) Provisional application No. 61/231,315, filed on Aug. 4, 2009.

(51) Int. Cl. G06F 17/30

(52) U.S. Cl. 707/723; 707/769; 707/E17.108

(57) ABSTRACT

A method and system dynamically matches real estate agent experience with property characteristics submitted by a customer through evaluating an agent's history of home closings in light of the requested home characteristics. The agent results may be displayed directly or integrated with search engine results.

### RELATED APPLICATIONS

The present application claims the benefit of U.S. Provisional Patent Application Ser. No. 61/230,979, filed Aug. 3, 2009, U.S. Provisional Patent Application Ser. No. 61/230,981, filed Aug. 3, 2009 and U.S. Provisional Patent Application Ser. No. 61/231,315, filed Aug. 4, 2009, each of which in incorporated herein by reference in its entirety.

### FIELD OF THE INVENTION

The present invention relates to real estate listing services. More specifically, the present invention relates to a system and method matching property characteristics or other real estate characteristics with relevant real estate agents.

### BACKGROUND

Choosing a real estate agent can be a daunting task. Currently agents are found through personal recommendations, associations with brokerages, advertising and internet searches and business networks. While each of these methods provides capability in reaching the agent's general target audience of buyers and sellers, the success in reaching the audience may not correlate well with selling success.

Attempts have been made to remedy this information gap. Some websites aggregate current house listings and associate the listings with an agent. Other websites assign a static rating, showing whether the agent is overall a “good” agent or “bad” agent. These overall ratings are then used to recommend agents to buyers or sellers. Thus, the websites suggest that an agent highly ranked overall will be an effective agent to the buyer or seller.

The problem with many rating systems is that they do not necessarily correlate with success in a particular market. For example, a real estate agent, who is successful at selling million dollar homes, may be much less effective at selling starter homes or condominiums. Also, a particular agent may have a good working knowledge of one part of a city and virtually no knowledge of pricing trends, amenities and other valuable information in an area even a few miles away or within the same ZIP code.

These results may be further manipulated by search engine optimization (SEO) specialists who hone in on specific search terms to bring a webpage's results higher in the SERP's. This may result in the SERP ranking elevation of a real-estate agent, who understands SEO, but does not necessarily understand how to sell a house in a particular area or with particular characteristics. In other words, the real estate agent may be able to rank well about houses in a neighborhood without actually having sales experience in that neighborhood, etc.

These deficits in the currently available information and search engines are very difficult to remedy for the common home owner or purchaser. Obtaining accurate information about a real estate agent's ability to sell homes in a particular geographic area or neighborhood and with particular characteristics is often near impossible. Yet, much evidence exists to suggest that a consumer receives the most benefit and value from a real estate agent who is well versed in handling transactions for properties that are similar in price, location, as well as other characteristics of the subject property. Thus, there is a significant need for a method and system which enables a home buyer or seller to obtain information about an agent that would be most desirable for their particular situation.

### SUMMARY OF THE INVENTION

It is an object of the present invention to provide an improved service matching consumers with relevant real estate agents based on their desired home characteristics and each given agent's past experience.

According to one aspect of the invention, a web service or computer based program returns proposed agent matches based on home characteristics. (For ease of reference, the program or method of the present invention will be referred to as a “web service”, although a non-website based system is contemplated and within the scope of the invention). More specifically, the web service compares the details of a seller's home or of a buyer's desired home attributes against an agent's history of homes for sale or purchase, whether it be home price, location or other characteristics. The web service then returns proposed agent profiles ranked according to their experience as related to the home. These dynamic results provide a better estimate of agent experience with a neighborhood and home characteristics than a generic agent rating.

According to another aspect of the invention, the web service or system may rate the agent based on impartial outcome information from real estate closing data because the closing data is required to be placed into the web service such that the web service's owner may be paid its part of the commission and the customer may be paid their rebate. In other words, the web service or system may calculate how close a listing agent came to obtaining full list price on the property, or how much of a discount the buyer's agent was able to obtain for his or her clients.

Additionally, the web service or system may include and evaluate additional factors, including, whether each listing posted on the MLS by a given agent sold, what the sale price was relative to comparable sales, whether it was priced competitively, the number of days a listing sat on the market prior to selling relative to comparable properties, and the difference between list price and sold price, etc.

It is another object of the present invention to provide improved search engine result pages (SERP's) with relevant experienced real estate agents.

According to one aspect of the invention, a search engine returns agent matches in the SERP's based on areas of expertise. More specifically, the web service compares the search terms against an agent's history of homes for sale or purchase, whether it be home price, location or other characteristics. The web service then returns proposed agent results ranked according to their experience as related to the search terms. These results provide a better estimate of agent experience with a neighborhood or home characteristics than a generic agent website content result.

These and other aspects of the present invention are realized in a web service or system which matches home characteristics with relevant real estate agents as shown and described in the following figures and related description.

### BRIEF DESCRIPTION OF THE DRAWINGS

Various embodiments of the present invention are shown and described in reference to the numbered drawings wherein:

FIG. 1 shows a flow chart overview of the interaction between the web service subsystems;

FIG. 2 shows a flow chart of the home seller's portion of the web service system;

FIG. 3 shows a flow chart of the home buyer's portion of the web service system;

FIG. 4 shows a diagram of system interactions in the web service system;

FIG. 5 shows a diagram of the home characteristic to agent ranking module;

FIG. 6 shows a screenshot of the buyer invitation to use the home-agent match web service system;

FIG. 7 shows a screenshot of the seller information survey system;

FIG. 8 shows a screenshot of the agent recommendations and the interface to the vetting module on a display screen;

FIG. 9 shows a screenshot of the bid comparison interface to the customer bid review and acceptance module;

FIG. 10 shows a screenshot of the agent profile interface to the agent database module;

FIG. 11 shows a screenshot of the agent results interface tab to the buyer search module on a display screen;

FIG. 12 shows an alternate screenshot of the information survey system as seen in FIG. 7;

FIG. 13 shows a screenshot of another embodiment of the agent recommendation interface and vetting module;

FIG. 14 shows a screenshot of another embodiment of the bid comparison interface to the customer bid review and acceptance module;

FIG. 15 shows a screenshot of the agent bid request interface;

FIG. 16 shows a screenshot of the agent submit seller proposal interface;

FIG. 17 shows a screenshot of the agent submit buyer proposal interface;

FIG. 18 shows a screenshot of the agent claiming interface;

FIG. 19 shows a screenshot of the manage client interface;

FIG. 20 shows a screenshot of the interface to the lead management subsystem;

FIG. 21 shows a screenshot of the auction proposal interface.

FIG. 22 shows a diagram of the interaction between the web search servers;

FIG. 23 shows a flow chart of the term-experience matching subsystem;

FIG. 24 shows a diagram of the professional experience to search term ranking subsystem;

FIG. 25 shows a search engine result page with organic experienced professional results;

FIG. 26 shows a search engine result page with profile enhanced organic experienced professional results;

FIG. 27 shows a search engine result page with organic experienced professional results and advertising that includes relevant certifications;

FIG. 28 shows a search engine result page with profile enhanced organic experienced professional results and advertising that includes relevant certifications;

FIG. 29 shows a search engine result page with professional results as supplemental to the organic result for the domain;

FIG. 30 shows a search engine result page with profile enhanced professional results as supplemental to the organic result for the domain with advertising that includes relevant certifications;

FIG. 31 shows a search engine result page with certified professional results as supplemental to the organic result for the domain;

FIG. 32 shows a diagram of a data collection server and its connection to other content servers.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

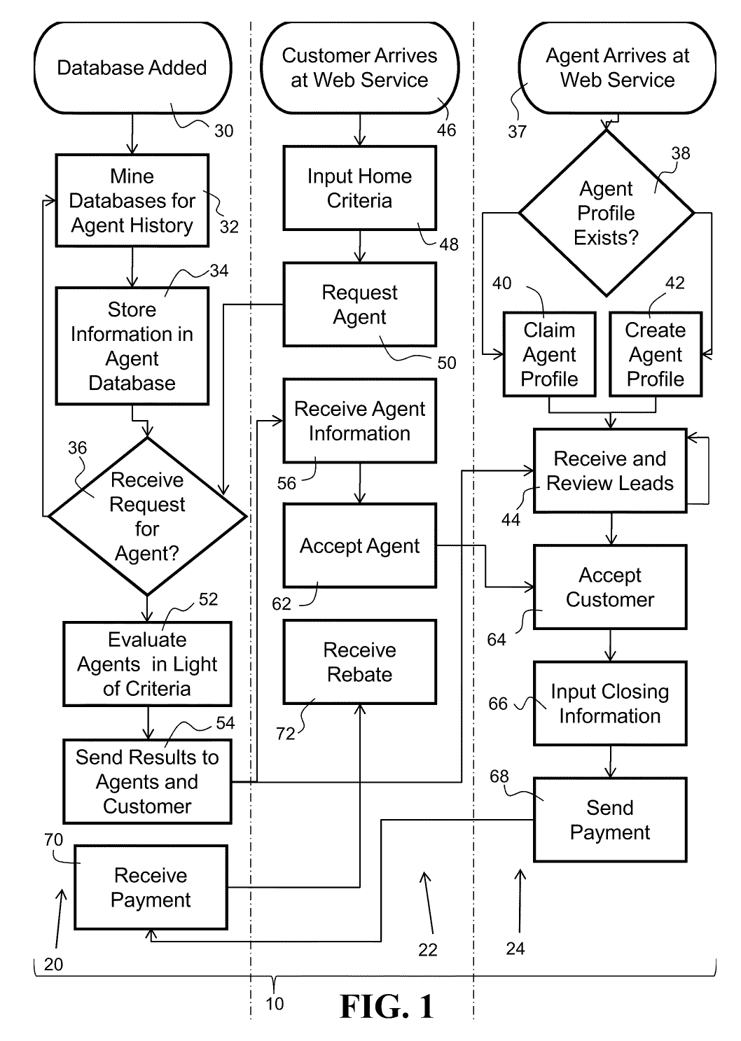

Turning now to FIG. 1, a flow chart is shown providing an overview of the interaction between the system, described herein as a web service system 10 and subsystems 20, 22, 24. (It should also be recognized that while a web service is likely the most common use of the invention, it may also consist of a client-server program or other system. Therefore, while the system may be described in terms of a web service for clarity, other systems, such as client-server, are considered and may be substituted where appropriate.).

An information management subsystem 20 communicates with a customer subsystem 22 and agent subsystem 24. These subsystems 20, 22, 24 interact with the purpose of matching characteristics of a home or desired home with an agent that has the most relevant experience and success in similar homes. This may include relevant experience such as home price, home location, home type, home size and other characteristics which may be important to home buyers.

As used herein, the term “customer” refers to an actual customer or a potential customer.

The information management subsystem 20 begins processing when it discovers a new data source and adds a database 30 (or ads to an existing database) for that source. Current data within the new database is mined 32 such that it may be associated with an agent's history in the agent database 34. Until a request for an agent is received 36, the information management subsystem 20 continues to monitor the data source and mine any new data 32 for association with an agent's database 34.

Meanwhile, an agent may arrive at the web service interface 37 for the first time. If the agent's information is already in the database and the agent's profile exists 38, the agent may claim the profile 40. Otherwise, the agent will be required to create a new profile 42 for inclusion in the database. Once the agent has a profile, she may check back from time to time to review any current prospective customer requests and profiles (i.e. sales leads) or receive new sales leads 44. Likewise, the agent may be notified of any new leads by a communication such as an email, text message, etc.

Meanwhile, a customer may arrive at the web service interface 46. The customer inputs his desired or actual home criteria 48, such as any variety of home characteristics and optionally specify agent characteristics, which may include gender, languages spoken, required years of experience, and whether the agent is an active real estate investor. The customer then submits the information to the information management subsystem 20 to request an agent 50.

In one embodiment, the subsystems then begin interacting with the purpose of matching the house characteristic information and, optionally the agent characteristics, submitted in 48 to an agent's history mined in 32. Each agent servicing the home area submitted in 48 is evaluated against the same home criteria 52. The system returns one or more agents 54 and communicates the results to both the customer subsystem 22 and the agent subsystem 24.

Both the customer in 56 and the agent in 44 receive the results of the request in 50. The customer receives a portion of the agent information 56; the agent receives a portion of the customer information 44. If the customer accepts the agent 62 and the agent accepts the customer 64, the agent begins work on finalizing any terms necessary to acquire the customer as a client. After reaching an agreement, the agent then works with the customer to purchase or sell real estate.

Upon closing of a real estate deal, the information is input into the agent subsystem 66 along with payment information 68, which is communicated to the information management system 20. The information management subsystem 20 receives the payment 70 and rewards the customer with a rebate 72 of a portion of the payment received 70.

In one embodiment, outcomes are monitored for the matched agent and customer. For a seller, a larger than expected price (per square foot or other home characteristics), properties they have closed as seller or buyer, re-list occurrences, property price fluctuations over time compared with the local, state and national markets and the amount of time on the market may be noted and stored as part of the agent's history with that sale. For a buyer's agent, similar statistics may be gathered and stored evidencing such characteristics as a lower than expected purchase price, quick closing or other desirable concessions. If no transaction is forthcoming, that failure may also be stored. Thus, the particular success of the agent may be dependent on performance of each real estate deal processed through the system.

Data attributes that may be used by the system to recommend agents to a customer include:
Agent's state license status
Number of past complaints with the state department
Number of active complaints with the state or Better Business Bureau
Office location
Average number of submitted offers internally tracked
Number and percentage of repeat customers
Number, type, and location of properties an agent owns
Languages spoken
MLS membership status
Total number of active listings
Total number of referred customers over a given timeframe
Buyer's agent history or seller's agent history
Price per square foot relative to comps
Days on market relative to comps
Difference between ask vs. sale price
Number of active listings weighted by similarity to subject or desired property
   Location of active listings
Number of sales represented on buy and sale side, weighted by similarity to subject or desired property, during a given time frame
   Number of homes sold during the last 180 days, 1 year, 2 years individually for each the buy and sell side of the transaction.
      Location of sold homes
Number of inactive listings and similarity to subject or desired property
   Location of inactive listings
Ratio of properties sold vs. listed
Number of buyers represented during a given timeframe
   Location and characteristics of sales
Number of sellers represented during a given timeframe
   Location and characteristics of sales
Publicly and privately available 3rd party ratings
   Analysis of 3rd party reviews
Internally sourced ratings and reviews
Number of price drops—for each property listed and/or sold, how many listing price reductions were made with the MLS by the agent in a given time frame
Length of time as MLS member or actively listing properties in a given geographical location
Level of diligence—on average per listing;
   Number of open houses that they conduct in a given time frame
   Number of property photos published
   Level of detail of their property description submissions
   Quality of their other property marketing materials

In-system performance may be monitored and scored as well. Negative reviews decrease match score, while positive reviews and frequent closing will increase match score. Work load and number of current leads may also be a factor used to spread work out and avoid a deluge of work on a specific agent in a hot market.

In another embodiment, the agent's history or “track record” is overlaid on a baseline or “hyper-local comparable market average” to evaluate the effectiveness of a realtor. For example, the price per square foot of the properties in each transaction that a realtor represented is compared with the geographically immediate comparable sales price per square foot (in last 6 months). The sale price versus listing price (“spread”) is evaluated relative to the same population and days on market (“DOM”). The system also evaluates whether the agent represented the buy or sell side compared with the current home characteristics request. The results of the comparisons are then aggregated such that a value may be given to an agent's history relative to the current home characteristics request.

For example, a buy side performance measure may compare a $212 price per square foot versus an average rate of $289 per square foot for comparable units in the immediate geographic surroundings, within the last six months, with market values trending upward during that period and give a positive match rating of +40 points. A seven percent list versus sell spread compared with a four percent average may give a match rating of +10 points. These points are then aggregated in a total match rating for the agent and compared with other agents that were relevant for the subject property's characteristics.

In another example, a sell side performance may compare 52 DOM versus an average of 92 DOM for the universe of comparable property sales in the immediate geographic area (1 mile radius, dependent on population density and number of qualifying transaction records returned) over the last 6 months and give +20 points match rating. A $252 price per square foot received versus a market average of $221 per square foot market average may give +50 points match rating. The system may also take into account recent market fluctuations and programmatically remove outliers and employ other techniques to remove anomalous transaction data, where applicable. These points are then aggregated in a total match rating for the agent compared with all other subject property qualified agents.

In one embodiment the match ratings are normalized such that the top match point value is given a rating of 99%. This communicates that the web service system believes the match to be the best agent for the job.

External data sources may be monitored and mined. These data sources may be from private or public bodies. The web service system may connect to external systems such as Multiple Listing Services (MLS) or information brokerages. The web service system may also connect to public data sources as well, including government sources, such as tax data, title data or even agent discipline data, as well as publicly and privately available websites. The data retrieved from these sources can then be used in the matching algorithm. For instance, an agent that turns up disciplinary violations may rank lower than a similar agent without those violations.

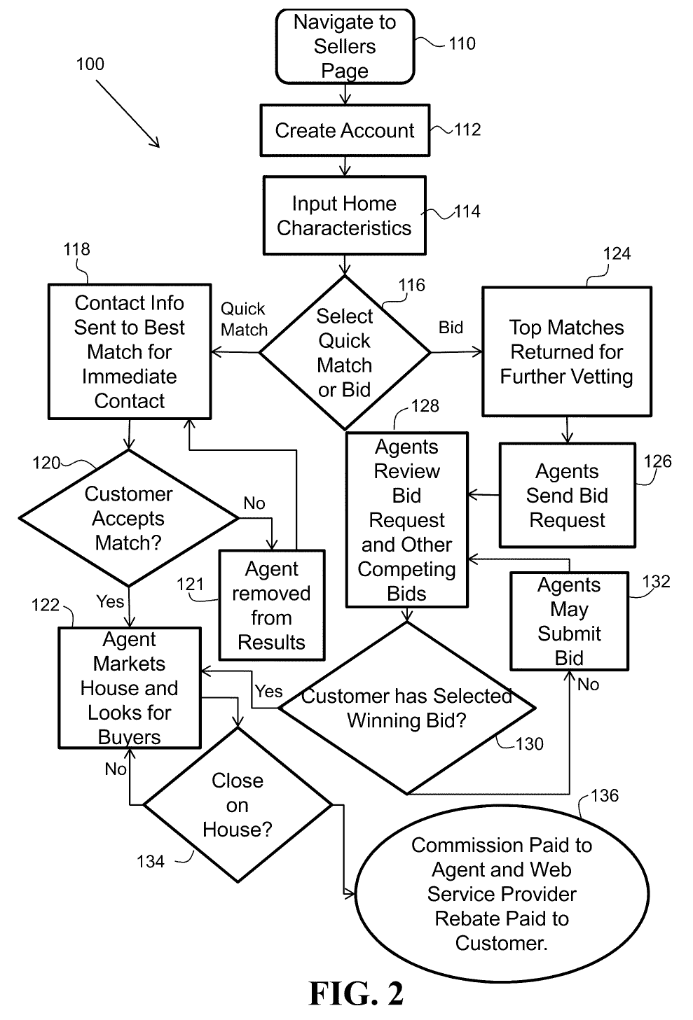

Turning now to FIG. 2, a flow chart of the home seller's interface portion 100 of the web service system 10 (FIG. 1) is shown. The home seller's interface portion 100 may be used to perform actions 46, 48, 50, 56 and 62 of FIG. 1 and effectively serves as part of the customer subsystem 22.

A seller who wishes to find an agent navigates to the seller's page 110 of the web service system 10. After creating an account 112, the seller inputs the characteristics of the home to be sold 114. The seller may then choose to have the system match the seller's home with the most highly relevant agent, a quick match, or may have a group of the most highly relevant agents bid to service the seller 116.

Should the seller select the quick match, the web service 10 compares the home characteristics with the agent's experience and selects the best match of an agent with the home characteristics 118. If the seller does not accept the match 120, the process may be repeated by removing the previously selected agent from the results 121. The next best match is then returned. Once the seller accepts the agent, the seller and the agent may begin their process of selling the house 122.

If the seller selects to have the agents bid on the project, the web service 10 returns a listing of the top agents matched according to the home's characteristics and allows the seller to remove any of the matched agents 124. The remaining agents may then be sent a request for a bid 126. The agents may then review the bid request and any other competing bids 128. If the seller has not already selected a bid 130, the agent may submit or modify their bid 132. Once the seller selects a bid 130, the agent and seller may begin their process of selling the house 122. Such a scenario enables agents to bid competitively for work which they find most appealing, and gives the seller the ability to obtain concessions such as larger rebates, waiver of exclusive listing agreements or other desirable terms.

Once the house has closed 134, the agent has the duty to report the closing through the web service system 10. The commission may be paid to the agent, who forwards the required portion to the web service owners A rebate incentive paid to the seller ensures that the seller has an interest in enforcing the agent's submission of the closing (including information and compensation) to the web service.

In addition, the system may be paid in different ways. The system may retrieve records that indicate that a sale occurred by a particular agent and at a particular address and therefore send an inquiry or invoice to a given agent who received a customer lead request. The system may also be named as the co-broker in a transaction, as the system may contain a licensed real estate brokerage, and its commission may be paid directly from escrow upon the close of a sale. The system may also utilize publicly available tax assessor and title data (transaction data) to compare against system activity data (allocated customer leads and their property criteria) to audit agent reporting activity in order to identify non-reported transactions.

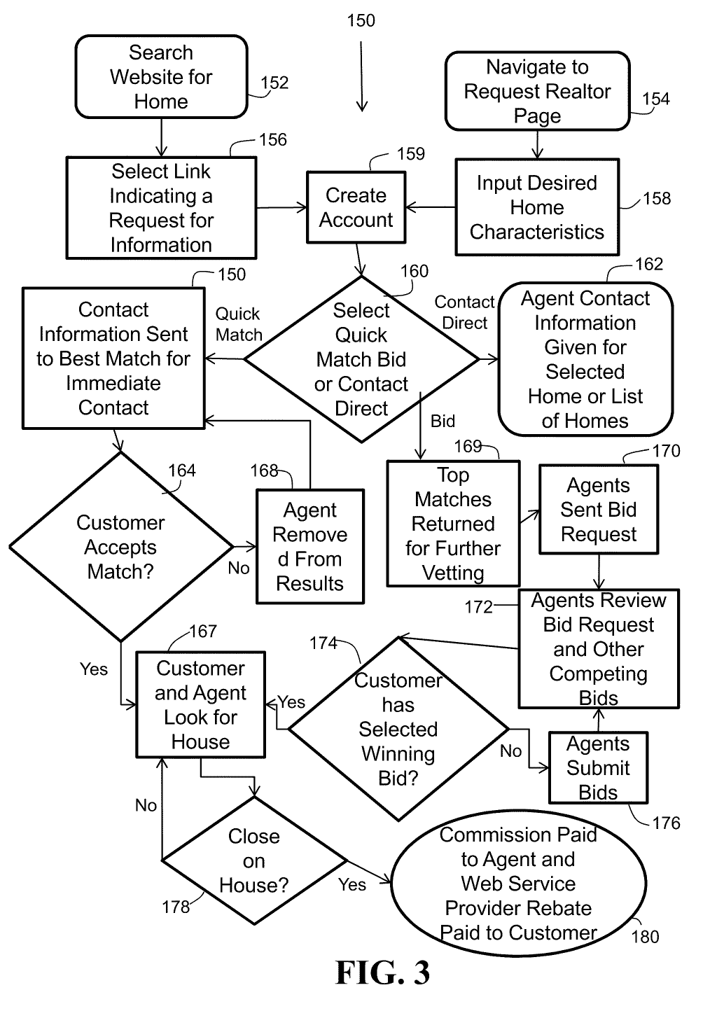

Turning now to FIG. 3, a flow chart of the home buyer's portion 150 of the web services system 10 (FIG. 1) as may be used to carry out steps of the customer subsystem 22 is shown. A buyer may either navigate to the web service by searching for a home 152 or by navigating to a request real estate agent page or interface 154. The web service system then requests information about the buyer's desired home characteristics. This may be auto-populated by selecting a link from a home result page 156 or manually filled in by the buyer 158. The buyer then may create an account 159 to access the web service system 10 if he does not have one already.

Once the buyer has completed the data entry phase, the buyer may select from three options 160. If the buyer had previously selected a specific house, the buyer may choose to contact the seller's agent directly 162. The buyer may alternately choose a quick match to an agent that best matches the desired home characteristics 164, and, if important, be immediately available. The buyer may instead choose to request bids from a list of top matching agents relative to the desired home characteristics. Such bids may be limited to a given time period, for example 48 hours.

If the buyer selects a quick match, an agent is notified of the match 164. If the customer does not accept the top matching agent 166, that agent is removed from the results 168 and the request may be repeated 164. Once the buyer accepts an agent, the agent and buyer may work together to find a desired home 167.

If the buyer selects to have the agents bid on the representation, the web service system 10 returns a listing of the top agents according to the match and allows the buyer to remove any of the matched agents 169. The remaining agents are then sent a request for a bid 170. The agents may then review the bid request and any other competing bids 172. If the buyer has not already selected a bid 174, the agent may submit or modify their bid 176. Once the seller selects a bid 174, the agent and buyer may begin their process of buying the house 167.

Once the house has closed 178, the agent has the duty to report the closing through the web service system 10. The commission may be paid 180 to the agent, who forwards the required portion to the web service system owners, or it may be paid directly to the system service owner as a licensed real estate brokerage. A rebate incentive paid to the buyer ensures that the buyer has an interest in enforcing the agent's submission of the closing into the web service system.

In an alternative embodiment, an online user can request information or schedule a viewing for a property, specifying that they would like to be contacted by a local expert. A system generated email will send the buyer's information, with exception of contact information, to a list of agents who have been filtered and selected using agent match. The first agent who “claims” the buyer and accepts the terms and conditions will receive the buyer's contact information. Once an agent claims the buyer, that agent will have exclusive access to the buyer's contact information. This alternative favors buyer response time as agents are encouraged to act on a first come first serve basis.

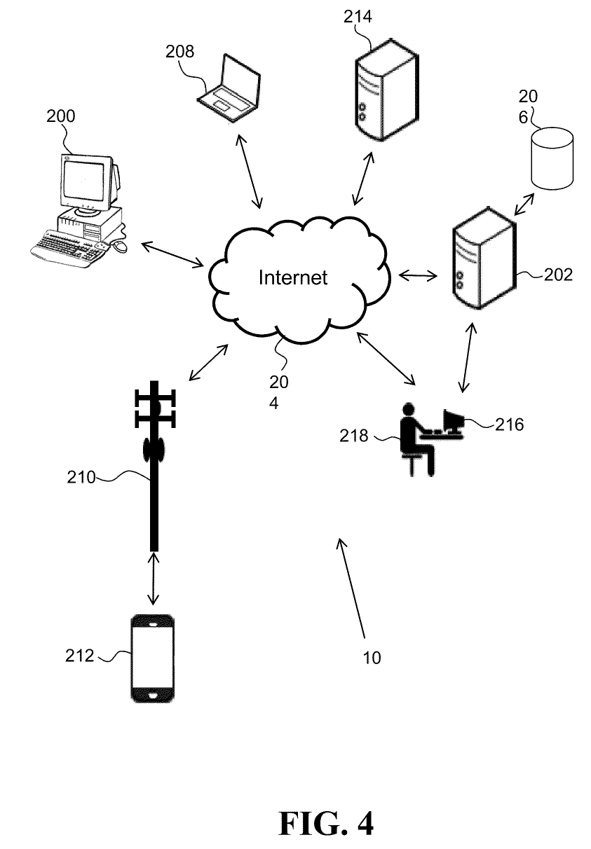

Turning now to FIG. 4, a diagram of system interactions in the system 10 as a web service is shown. A customer computer 200 may contact the web service system server 202 through the internet 204. When a search is requested, the web service server 202 may request data from internal local or network database servers 206 to make the ranking decisions with the agent history compared with the customer submitted home characteristic data. Once an agent has been selected for contact, the agent may receive notification from a number of different sources including email on a personal computer 208, a text message sent through a wireless carrier 210 and delivery to a mobile device 212. The agent may also use similar methods to contact the web service server 202 to review any potential clients.

The web service system server may also be connected with other services. For instance, Multiple Listing Service (MLS) 214 data may be queried for data on the neighborhood, agent history, data verification and status of any pending closing. Other data sources may be similarly queried for useful data to be included in the database servers 206. Should any problems be detected or customer requests received, the web service system server 202 may communicate with a customer support system 208 for follow up by a customer support representative 218.

The web service system may require agent pre-approval based on an acceptance of terms of service from the agent or the agent's brokerage, including a co-cooperative brokerage agreement, and an experience and license status check. The pre-approval may further assure customers that poor agents have been vetted from the system and only transitionally relevant agents returned. It will also assure that any agent is contractually bound to pay the appropriate portion of the sales price to the owner of the web service system.

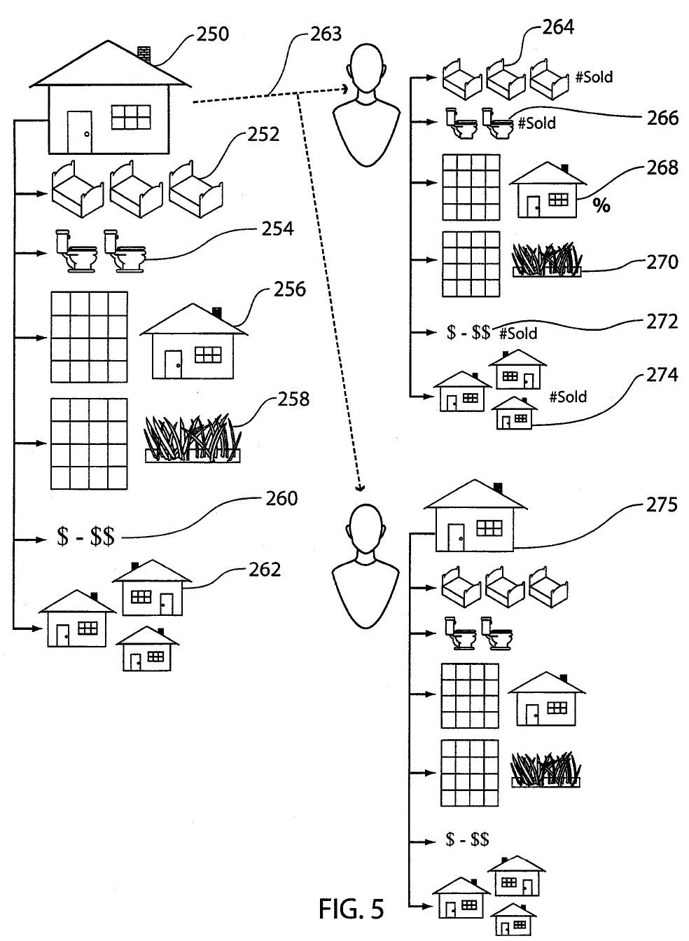

Turning now to FIG. 5, a diagram of the home characteristic to agent ranking module is shown. Using home characteristic data 250 entered by the potential customer, each data field is compared with the stable of homes sold by the agent. The advantage of the system is that an agent's experience is matched to the home characteristics. An agent who normally sells million dollar homes may be inexperienced in selling starter homes because the needs, desires, trade-offs, market conditions, and their existing buyer or seller customer and broker contacts are different. Consequently their ability to facilitate a transaction is likely to be limited. Likewise, an agent well versed in selling single family homes, may have little experience with condominiums and the like. Thus, in accordance with the present invention, it is desirable to improve the match between the customer's needs and the experience of the agent who will be working with the customers.

In one embodiment, the number of bedrooms 252, bathrooms 254, square footage 256, lot size 258, price range 260, and/or neighborhood 262 are compared 263 against the number of homes sold by the agent with similar bedrooms 264, bathrooms 266, square footage 268, lot size 270, price range 272 and/or number of homes sold at or near the desired neighborhood 274. This is referred to herein as an agent experience match system.

In an alternate embodiment, each home purchased or sold by the agent 275 is rated on the home data 250 provided by the customer. Each agent home rating is then aggregated to form a match rating. This is referred to herein as an agent home match system.

Each of the agent home criteria may be weighted such that inexact matches contribute a partial rating, such as a two bathroom house contributing a partial rating to a desired one and one half bathroom house, because of the close proximity to the desired result. These rating weights may be based on a selected importance by the customer or pre-set by the web service system. For example, one seller-user may give more weight to hastening and ensuring a transaction while another user is looking for the highest sale price or the lowest acquisition price, irrespective of timing.

Further, static data may also be included in the result matching system. For example, it has been noted that there is likely a correlation between response time to a customer request and a positive real estate outcome. Therefore, an agent may also be rated on her responsiveness to the customer over a series of interactions. Additionally, the system will use the conversion or transaction rate of a given agent as a ratio of the number of successful transaction relative to the total number of customer leads allocated over a given time period.

These static data points may be pre-compiled and stored along with the agent's other static data, such as contact information. When the home-agent matching system is requested by a customer, a portion of the agent rating may depend on such static data, but the rating overall is dynamic, based on the home characteristics submitted.

Overseeing the customer and agent experience may be a customer service subsystem. The customer service subsystem may monitor a customer's interaction from the website, including from the customer's first arrival on the web service system to the wrapping up of closing on a home. It may further monitor agent activities and interactions. By monitoring customer progression and agent activities, the customer service subsystem may be able to not only create reports of activity, but also detect potential problems and deploy customer service representatives to proactively resolve those problems.

In one embodiment, the customer service subsystem requires progress report submissions on a bi-monthly basis by the agent. In the event an agent misses progress report submissions multiple times, they may risk having their customer removed and given to another agent as well as a negative impact on the agent match score.

If the system detects a problem, such as lack of customer progression, a customer service representative may be notified. The customer service representative may be instructed by the system to start by sending a simple email to the customer or agent, or the system may automatically send an email in the customer service representative's name requesting further information or asking how the process is going. If the system or customer service representative does not receive a response, the system or customer service representative may escalate the attempt to a phone call. Should the system and customer service representative attempts to contact fail, the system or customer service representative may choose as a last resort to make the agent account inactive until further contact and to allocate the customer request to a new agent, based on system settings and company policy.

The purpose of the customer service subsystem may be to enable the customers and agents to work together to achieve the sale or purchase of real estate. The customer service subsystem may include frequently asked questions (FAQ) and online intervention forms for customer service representatives, which may intervene to attempt to resolve conflicts.

This system may also include the ability to privately message one another, leave a message on an online bulletin board as well as trigger emails and send messages to mobile devices. The agent or customer may search homes, select favorites or create a favorites list. The agent or customer may also compare properties on their attributes, schedule property viewings/tours, provide feedback on particular properties viewed and thereby actively curate the list to reflect the evolving preferences of the customer.

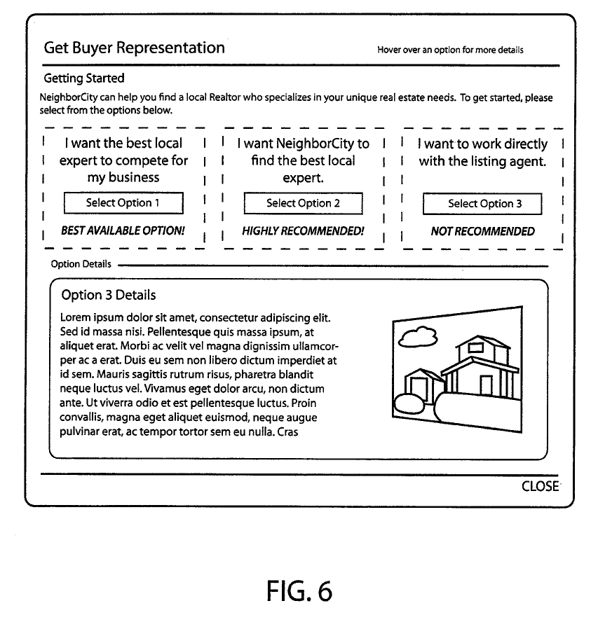

Turning now to FIG. 6, a screenshot of the buyer invitation to use the home-agent match web services is shown. The buyer may select from the three options as previously described: contact the seller's agent directly, use quick match or request bids to obtain buy side agent and brokerage representation.

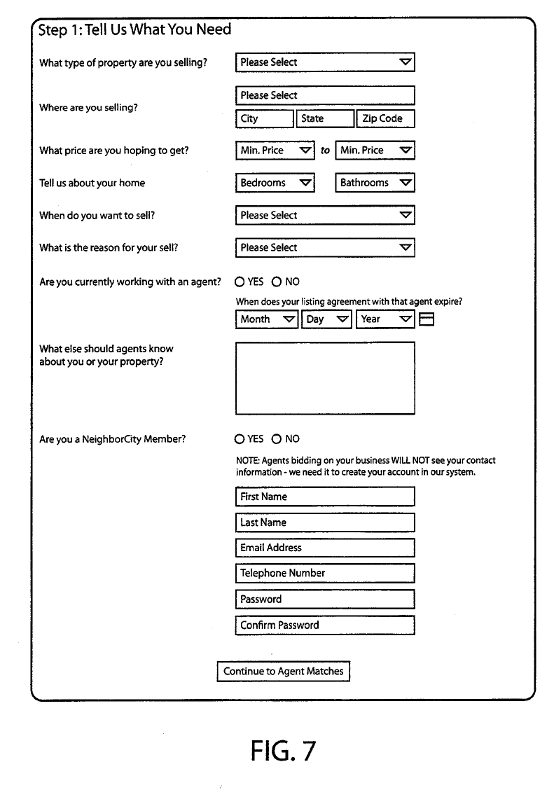

Turning now to FIG. 7, a screenshot of the seller information survey system is shown. The seller is requested to fill out a survey of the home's characteristics for use in the home-agent matching system and other important data. This data may then be used to dynamically rate an agent's experience in selling similar homes.

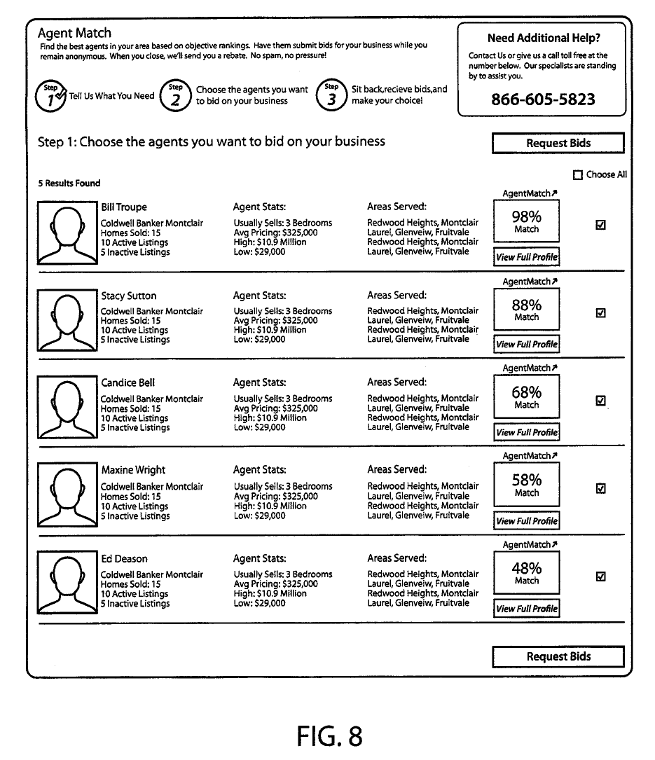

Turning now to FIG. 8, a screenshot of the agent recommendations and the interface to the vetting module is shown. If a bid is requested by the customer, the top matched agents are shown. The customer has an opportunity to refuse any of the agents based on their personal biases. This vetting module is useful to prevent an agent from wasting time to bid on an opportunity when the customer would never select the agent based on some characteristic or bias. For example, some customers may never choose an agent who worked for a national firm or an unrecognized brokerage. Likewise, a customer may prefer to have an agent who is of the same gender, same age or other characteristic so that the customer may inquire of the agent about issues which may be important to the customer. Thus, for example, a 25 year old woman may select an agent of a similar age and gender to consult on local nightlife, the dating scene and the perceived safety of particular neighborhoods. In contrast, a retiree may seek a 60 year old plus agent to gain insights about the suitability of a neighborhood and local attractions for grandchildren, etc., or amenities for the elderly. Likewise, a person may prefer an agent that speaks his or her native language over those who do not.

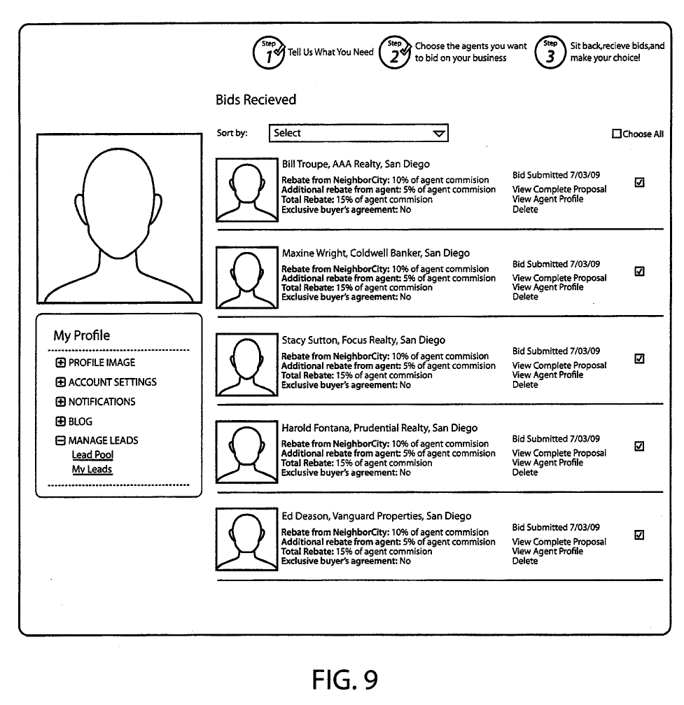

Turning now to FIG. 9, a screenshot of the bid comparison interface to the customer bid review and acceptance module is shown. The agents, having submitted bids through the web service, compete to be selected by the buyer/seller. The bid comparison screen shown is a summary/comparison screen that allows the seller/buyer to compare key statistics related to the agent representation. The customer may further drill down into the specifics of the offered representation by clicking on a link.

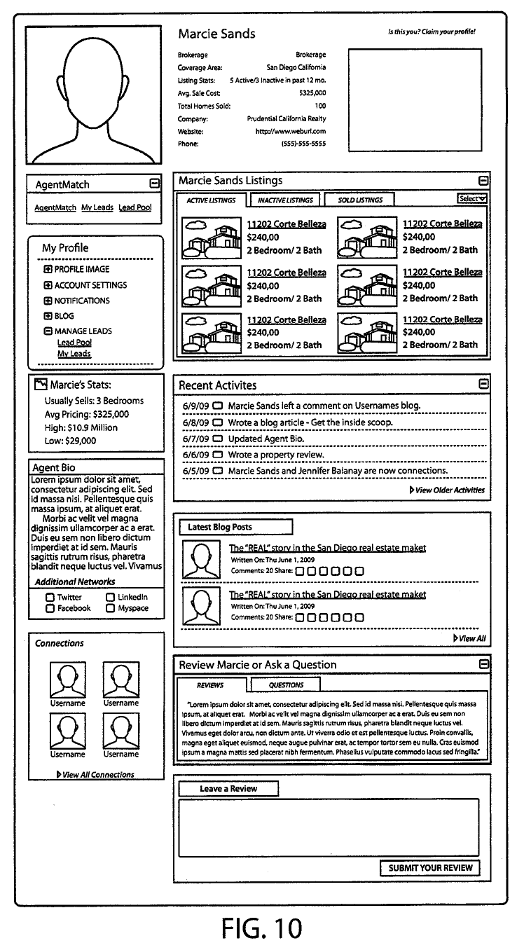

Turning now to FIG. 10, a screenshot of the agent profile interface to the agent database module is shown. The agent profile interface displays a selection of the information collected about the agent by the web service system. This may include contact information, current listings, past listings, blog links/posts, customer reviews, answered questions, twitter posts, recommendations and other information gathered by the web service system. The information may be further condensed into summary statistics. For example, as seen in the screenshot, an agent's home data may be summarized into an average price, high and low sales prices, and a usual number of bedrooms in the home sold.

The agent profile may serve as a reinforcement of the home-agent matching system. After receiving a recommendation by the system, a customer may browse the agent's profile to gain confidence that the agent services similar homes. When the customer views the agent's data listings, listing history and sales history, the customer may feel more comfortable in the agent's knowledge. This may be further bolstered by other gathered data such as blog posts, twitter posts and answers.

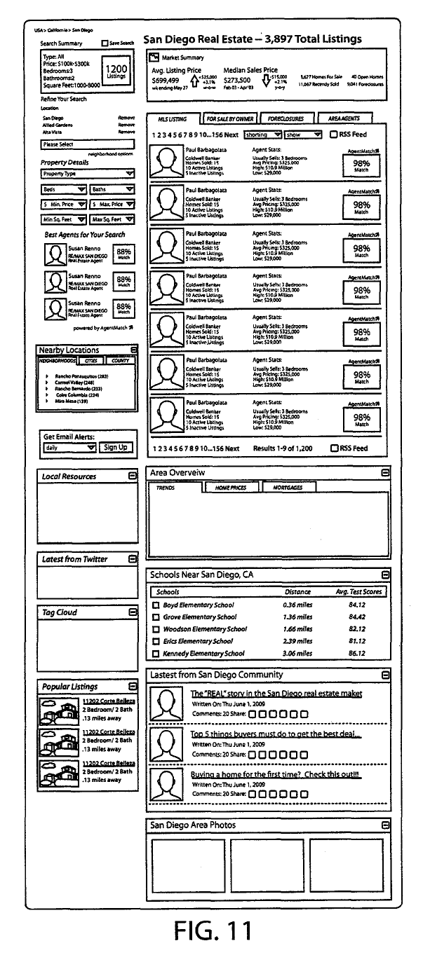

Turning now to FIG. 11, a screenshot of the agent results interface tab to the buyer search module is shown. Based on a customer's search performed for houses in a neighborhood/area, the web service populates the area agents tab with agents ranked by their score which is dynamically created based on the home search criteria input by the customer. Should the customer choose to select one of the agents, the web service system may start the quick match process with the selected agent as the result. In another embodiment, the web service will ask whether the customer wishes to request a bid from that agent or from a group of agents.

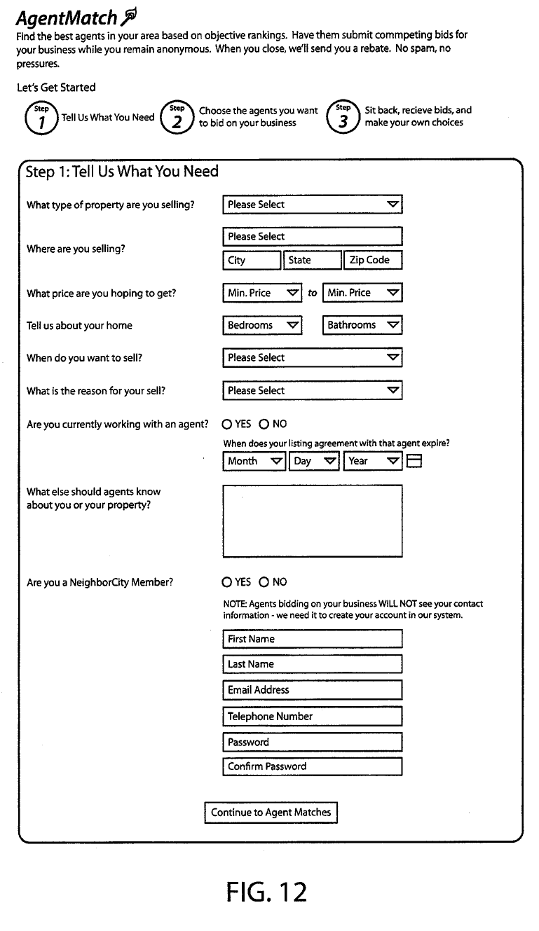

Turning now to FIG. 12, an alternate screenshot of the information survey system as seen in FIG. 7 is shown. After deciding to receive the agent match benefits, a seller is requested to fill out house characteristics that may be used by the agent match system. A seller may optionally specify a target time frame when they would like to sell their home. In one embodiment, the system may auto-populate the fields from previously stored data based on an address or MLS number. The client may then have the option to update any information that is out of date.

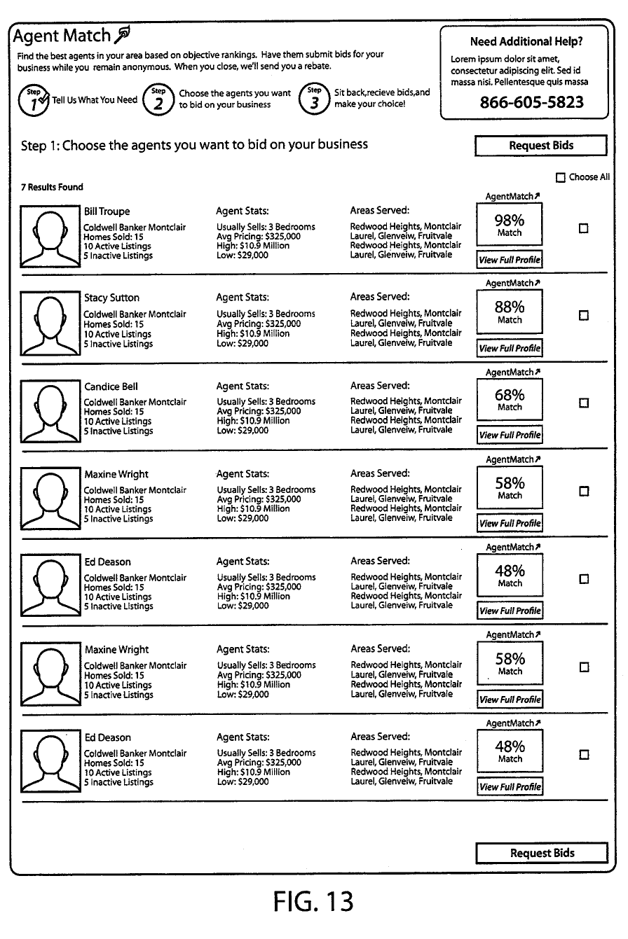

Turning now to FIG. 13, a screenshot of another embodiment of the agent recommendation interface and vetting module is shown. In one embodiment, after filling out the survey data, the client is presented with this screen on their display. Agent profiles are accessible from the agent name links, areas served are linked to area profiles, and the summary statistics of the agents are shown. The client may use any of this available data in vetting any agents from the bidding process based on their personal bias, desires or needs.

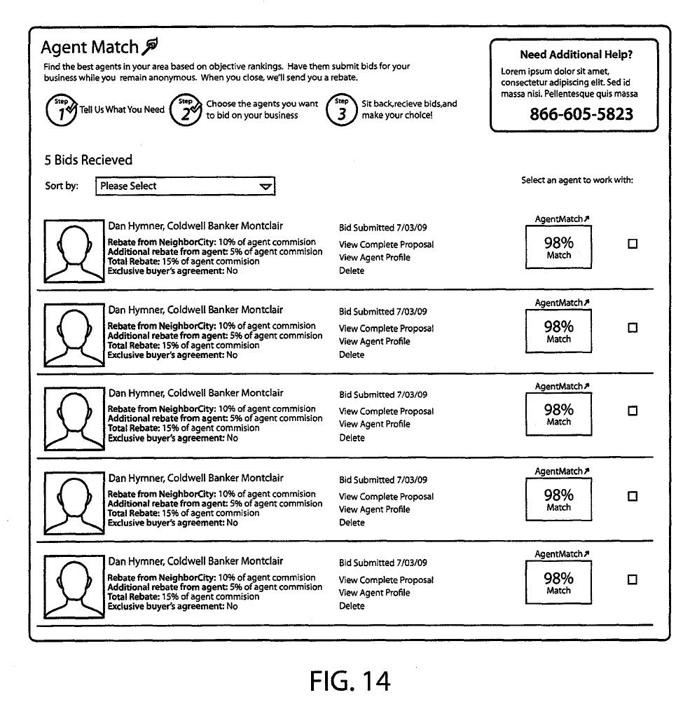

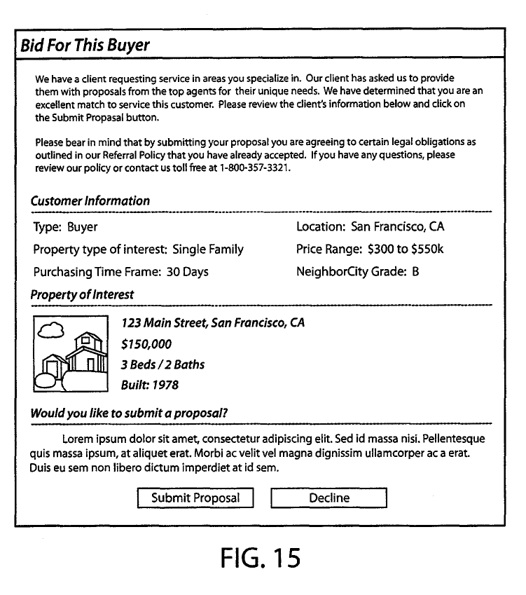

Turning now to FIG. 14, a screenshot of another embodiment of the bid comparison interface to the customer bid review and acceptance module is shown. After the customer has selected the potential agents from which to receive bids, the agents receive a message (such as in FIG. 15) requesting a bid. Any agents who submit bids will be shown on this interface and associated with their bid. Once a satisfactory bid is made, the client may accept the desired bid.

Turning now to FIG. 15, a screenshot of the agent bid request interface is shown. After a client has requested selected agents to bid, an invitation to bid is sent to the selected agents. The agent may then choose to submit a proposal, decline involvement or, in some cases, request more information.

In one embodiment, the web service system also gives the client a rating. The web service system mines data about the client and gives them a rating. This mined customer data may include data from the survey, a credit report, or internal or external or other free or paid database requests.

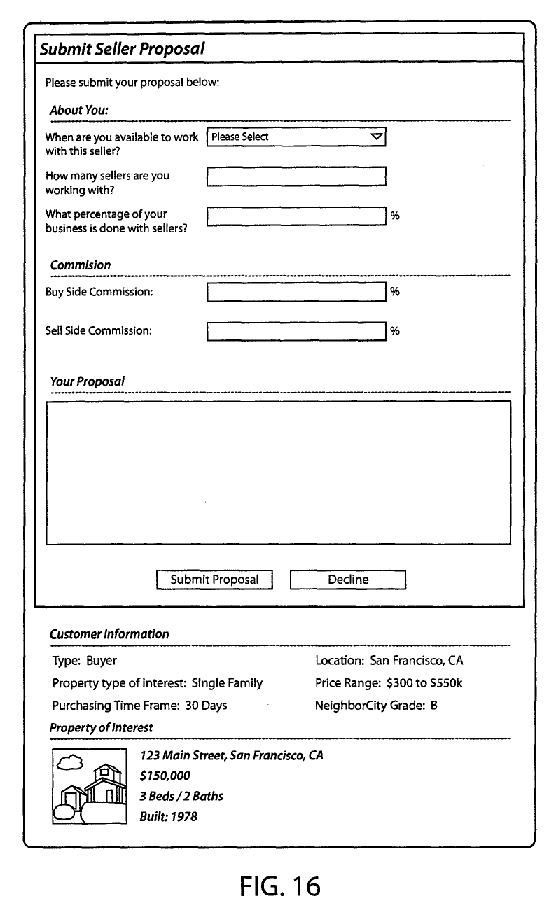

Turning now to FIG. 16, a screenshot of the agent submit seller proposal interface is shown. After having received the invitation and selected submit proposal, the agent is then requested to fill out the proposal survey. The proposal survey may include several fields for computing summary data and an information box for other terms not included in the fields. Once submitted, the information may then show up on the client bid comparison interface as seen in FIG. 14.

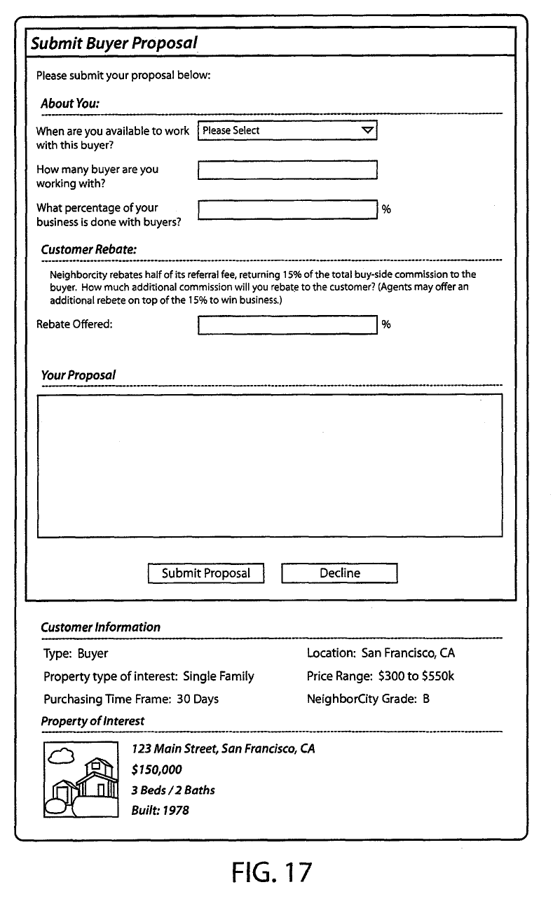

Turning now to FIG. 17, a screenshot of the agent submit buyer proposal interface is shown. Similarly to FIG. 16, after having received the invitation and selected submit proposal, the agent is requested to fill out the proposal survey. This information is then relayed in a similar manner to the client.

While the screenshots show a web page, the system of the present invention may use other means of communication, such as SMS, XML, push notification, email and other technologies to ensure that the client and agent are notified of any changes in the bidding process. Similarly, the system may accept communications in modifying, submitting or accepting bids.

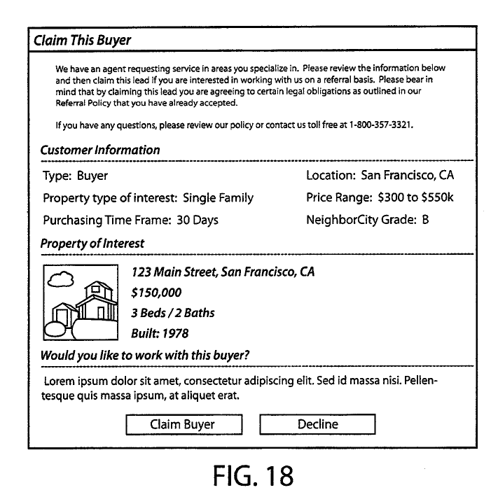

Turning now to FIG. 18, a screenshot of the agent claiming interface is shown. If the client has chosen the quick match feature of the web service system, once notified, the agent may accept or decline the invitation to become the agent for the client. If the agent declines, the web service system may exclude the agent from the results and give the next highest match an opportunity.

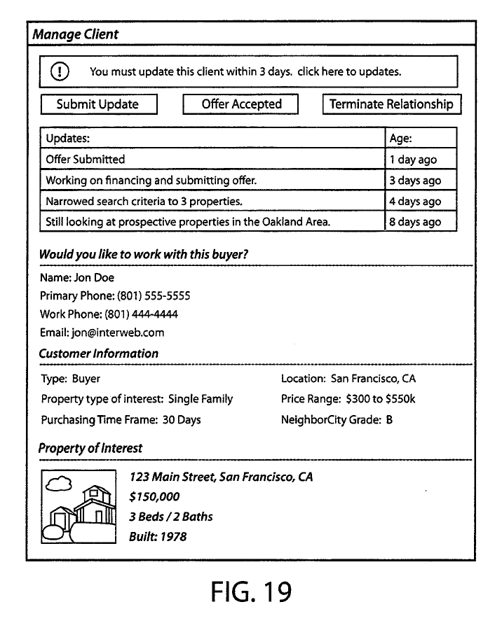

Turning now to FIG. 19, a screenshot of the manage client interface is shown. Once a relationship has been confirmed by both parties, the system may keep track of the interaction between them. In this screenshot, it may be noted that the relationship has progressed from looking in a general area (i.e. Oakland), to narrowing the search, to composing an offer, to the current status of waiting for a response. By tracking communications between the parties, current status and the history of status, the web service system may detect relationships in danger of souring and initiate alert or warning messages to the agent and customer service representative responsible for the particular customer. The customer service representative may then respond to both parties and ensure a satisfactory resolution. Further, by tracking the interaction, an agent may be rated on her attentiveness, time taken for each status step and other indicators of active client service.

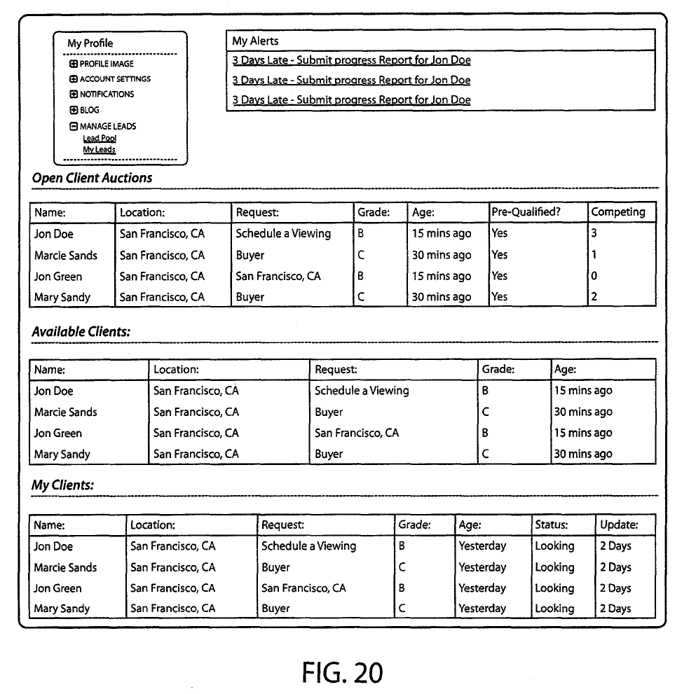

Turning now to FIG. 20, a screenshot of the interface to a lead management subsystem is shown. An agent may actively manage their workload in the web service system by ensuring that current clients are recently contacted and by bidding or accepting potential leads when the current client list contains too few current clients. The information includes current status, such that the agent may remember the current goals and next steps for each client.

A lead management subsystem may direct the distribution of customers and monitor agent progress with the customers. In some cases, as above, the lead management subsystem will monitor reverse auctions. In other cases, as above, the lead management subsystem will monitor a quick match. However, the lead management subsystem may monitor other forms of customer acquisition including co-representation opportunities, leads and marketing responses.

In one embodiment, the lead management subsystem manages referral opportunities. Referral opportunities may come from people such as customers, clients or agents. After working within the web service system, agents may prefer to have the organization and tools provided within the web service system and therefore request their clients register for an account on the web service system. Other agents may not be familiar with or willing to represent a client and may therefore recommend the web service system. These referral opportunities may be tracked, and the number and frequency recorded, such that a frequent referring agent may be thanked and/or rewarded.

Once the referral opportunity has been given to the web service, the lead management subsystem may utilize an agent's match rating to inform the referrer of a good match, warn of a poor match or give recommendations based on the firm requested. Once informed, the customer or agent may then complete or abandon the referral. If completed, the system may then contact the selected agent and/or the customer to encourage the relationship to form and any terms and conditions to be accepted.

The match system may also be used to independently look up an agent that was recommended and give a match rating.

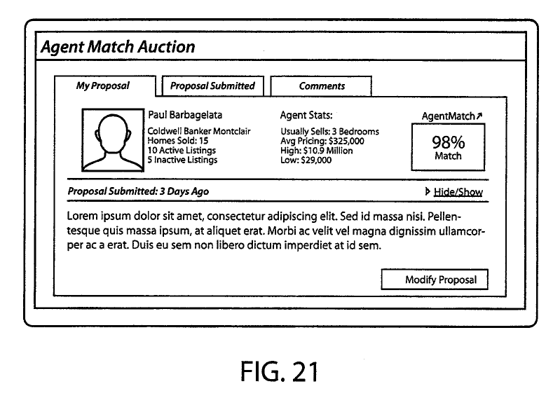

Turning now to FIG. 21, a screenshot of the auction proposal interface is shown. Once an agent has submitted a proposal, the proposal may be reviewed from this interface. The interface also contains other agent proposals for comparison. If the client or agents have specific questions or needs outside the bid, either party may make non-binding suggestions on the comments tab that may suggest important provisions that were not part of the original client submission.

While the previous discussion has centered on a customer searching for an agent, the match system may also be applied when a customer is searching for a house. Information contained in the search may be examined to create a request for a match from the information management subsystem. These agent match results may be shown in a sidebar along with the home results.

As used herein, the term “sidebar” refers to a location separated from primary content, including a location that may separate portions of primary content. For example, a sidebar may be located on the sides or top or bottom of a display area, or it may be located in between paragraphs of primary content. In the example above, the home search results may be the primary content and the agent match results may be the sidebar.

Search results may be examined in different ways to gather information to use in the request for a match. If the search uses home characteristics, those characteristics may be directly sent with the request for a match. If the request is for a neighborhood, the neighborhood may be examined for current characteristics and median or average values for the characteristics selected and sent with the request for a match. If the request is for a home, the home characteristics may be used or the broader scope of the neighborhood used and sent with the request for a match. Search history may also be used, where the results of the customer's search may be aggregated and used to determine the characteristics to be sent with the request to match.

These matches may then be used to pull relevant content from the agent information stored in the information management subsystem and display it to the user. Relevant information may include such things as agent profile photographs, home photographs, match rating, date the last home was sold, number of homes sold, average time on market and other statistics that may be tracked or derived from information in the information management subsystem. The click-through ratio may also be monitored such that the most relevant information for similar searches may be used.

The web service system may calculate areas of expertise for agents. An area of expertise is specific knowledge that may be attributed to an agent. The data in the information management subsystem may be used to calculate of such areas of expertise. Areas of expertise may include individual characteristics such as an individual area of expertise in a neighborhood, as evidenced by an agent's representation of numerous buyers or sellers in a neighborhood. Similarly, an agent may have an aggregate area of expertise in “First Time Homebuyers” which may be evidenced by individual areas of expertise in a price range, typical customer ages and FHA loans. These areas of expertise may be used to supplement information in the sidebar results related to searches or even appear on agent profiles.

Agent profiles may also benefit from match rating, areas of expertise and search results. When viewing a profile, the web service may review any searches performed by the customer and place them in a sidebar to the profile. The sidebar may then also include match ratings for the agent to the prior search results in the sidebar. Further, the search results may be examined by the web service and relevant areas of expertise may be placed on the agent's profile. For example, an agent who has subcharacteristics such as experience in a price range, typical customer ages and FHA loans may show the area of expertise in “First Time Homebuyers” to a customer who may be searching relevant houses to a “First Time Homebuyer.” However, to a customer that is not in the age nor price range, but has searched on terms relevant to FHA loans, the agent profile may display “FHA Experienced” in the place of “First Time Homebuyer.”

While the present invention can be used specifically for searching and executing the method within a web-based service or in a system which is run on individual computers, etc., aspects of the present invention can also be used in the context of a search engine to improve searching for agents and in particular for generating improved search engine results pages (SERPS), etc. While discussed below as a web search system based process, it will be appreciated that it could be performed on intranets or other computer systems which are capable of receiving a relaying the needed information.

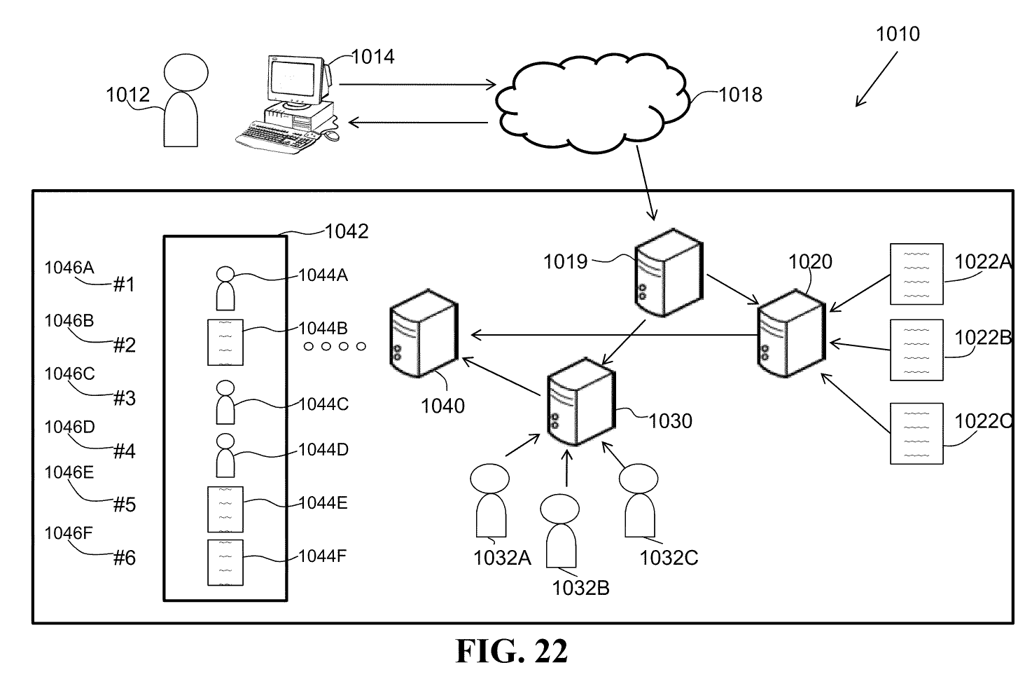

Turning now to FIG. 22, a diagram is shown of internal interactions of a search system 1010 between an internet document server 1020, an agent profile server 1030 and a result server 1040. User 1012 through an internet connected device 1014 submits a search request to web search system servers 1016 through the Internet 1018 and receives results 1042 of the search.

In one embodiment, the search request is captured by dispatch server 1019. Dispatch server 1019 may forward the request to internet document server 1020 and agent profile server 1030. In the case that dispatch server 1019 has been enhanced, dispatch server 1019 may detect whether the search is appropriate for internet document server 1020, agent profile server 1030 or both. Dispatch server 1019 with enhancements may then forward the search request to the appropriate servers.

Having received a request from dispatch server 1019, internet document server 1020 may gather and rank relevant internet documents 1022A, 1022B and 1022C based on the search request received. These documents and their associated ranking scores are then forwarded to result server 1040 for aggregation and sorting.

Agent profile server 1030 may also receive the search request from dispatch server 1019. Search terms within the search request may be examined for professional areas of expertise. Using the areas of expertise and any modifying terms within the search request, relevant agent profiles 1032A, 1032B and 1032C are gathered and ranked. The profiles and associated ranking scores are then forwarded to result server 1040 for aggregation and sorting.

Result server 1040 organizes results 1042 according to the rankings submitted for each result element 1044A, 1044B, 1044C, 1044D, 1044E and 1044F. The result server may then determine the final order 1046A, 1046B, 1046C, 1046D, 1046E and 1046F of the result elements. Results 1042 are then communicated to internet connected device 1014 and displayed to user 1012. In one embodiment, result server 1040 compiles the results into a web page and sends the web page to internet connected device 1014.

In some cases, there may be difficulty measuring the relevance of an internet document compared with an agent profile. Therefore, it may be useful to scale the rankings such that both sets of results may be combined. In one embodiment, the result server may normalize each result set such that each result set may have the same total result value, but individual results may vary. In another case, each server may normalize the result set to a maximum relevance value. When the sets are then combined, the result with the best relevance ranking will then be at the top of the search engine result page (SERP).

The SERP may be constructed on many different technologies. While SERP's are discussed as web pages for clarity, it should be recognized that many different technologies and communications may be used. For instance, the SERP may be constructed in or contained within HTML, XML, XHTML, RSS technologies, ATOM, AJAX, Document Object Model, email, text, PDF, SMS, push notification and other communications or documents that may hold the SERP result data.

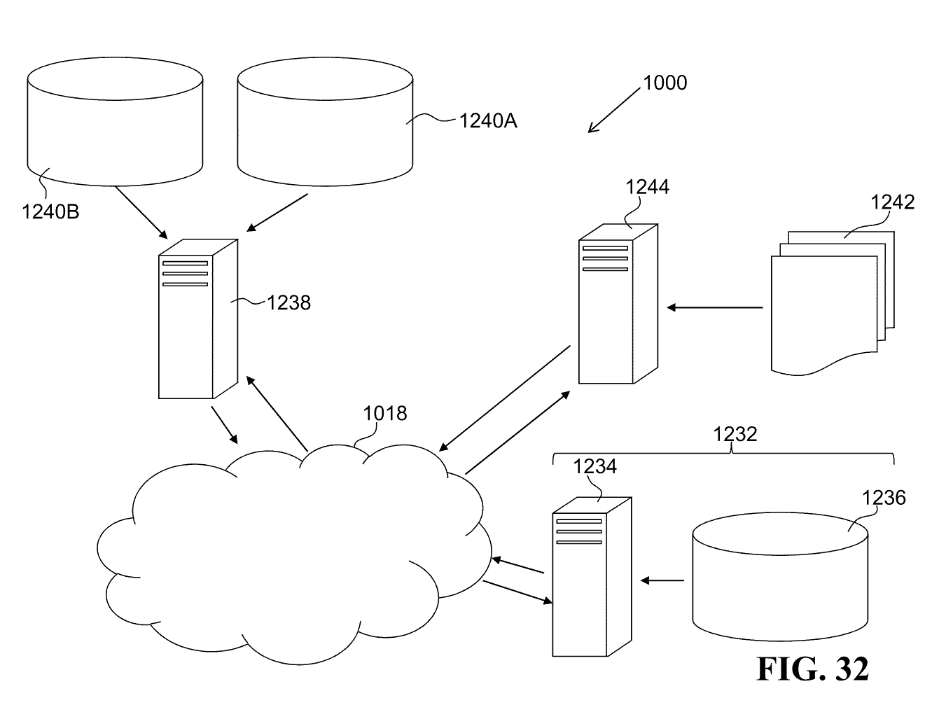

An information management subsystem (see FIG. 32 for more details) may keep the agent profile server data up to date. It may begin gathering when it discovers a new data source and adds a database for that source. Current data within the new database is mined such that it may associate current data with an agent's history and area of expertise in an agent database. Until a search for an agent is received, the information management subsystem may continue to monitor the data sources and mine any new data for association with an agent's database.

The information system may calculate areas of expertise for agents. An area of expertise is specific knowledge that may be attributed to an agent. The data in the information management subsystem may be used to calculate such areas of expertise. Areas of expertise may include individual characteristics such as an individual area of expertise for a real estate agent in a neighborhood, as evidenced by an agent's representation of numerous buyers or sellers in a neighborhood. Similarly, an agent may have an aggregate area of expertise such as “First Time Homebuyers” which may be evidenced by individual areas of expertise in a price range, typical customer ages and FHA loans. Discussed above are a large number of factors which may be used in ranking a particular real estate agent as being relevant to a particular home, neighborhood, house type, etc., and any of those factors may be used in compiling results regarding the expertise of an agent.

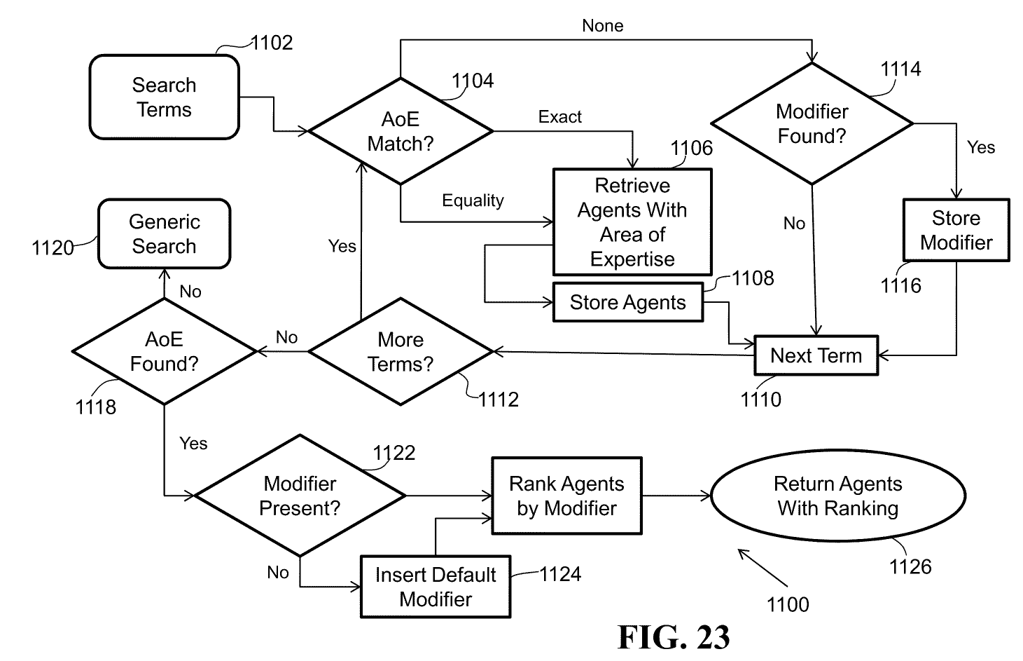

Turning now to FIG. 23, a flow chart of term-experience matching subsystem 1100 is shown. While the subsystem process is shown for agent profiles for clarity reasons, it should be recognized that the process is similar for other agents. It should also be recognized that search terms may be broken up into term units. Term units may be further broken down into other term units or combined to make new term units. Therefore, the available number of term units may be greater than the number of original search terms, depending on the analysis algorithm.

The search terms 1102 are received by term-experience matching subsystem 1100 and broken down into smaller term units, if possible. Each term unit is examined to see if they match an area of expertise 1104. If the area of expertise is an exact match or found to be equivalent, the agent database retrieves agent profiles with the requested area of expertise 1106. The agent profile results are stored for later examination 1108. The next term unit is then requested 1110 if there are more term units 1112. If more term units are available, the matching process begins again at whether the term unit matches an area of expertise 1104.

If the term unit does not match an area of expertise 1104, the term unit will be examined for a modifier 1114. If the modifier is found, it will be stored for later use 1116. In either case, whether the modifier is found or not, the system will move to the next term 1110, if any are available 1112.

A modifier may represent a specific need related to an area of interest. Simple modifiers may include “must,” “not,” and “never.” For instance, if a search requests an area of expertise “must” include farmland, agent profiles without farmland experience should be excluded. Modifiers may also include minimum, maximum, level of desire, level of importance or other ranges, cutoffs, or weights to include in the ranking algorithm. Modifiers may also be implicit in the term units because of order, punctuation, overall context, local context and expected default behavior.

Once the term units are exhausted 1112, the term-experience matching subsystem 1100 checks to make sure that at least one area of expertise was found 1118. If not, the term-experience matching subsystem 1100 returns a message signaling that there are no results 1120. In this case, the system suggests that a more generic search should be performed.

If at least one area of expertise was found 1118, term-experience matching subsystem 1100 also checks for modifiers that may alter the ranking algorithm 1122. If no modifiers are found, then a default modifier for the ranking algorithm will be selected 1124. The agent profiles are then ranked 1126 and returned with their ranks.

The ranking algorithm may result in a general relevance rating for use in comparison with other internet documents, or it may produce an intermediate ranking which may be scaled for relevance comparison with other internet documents.

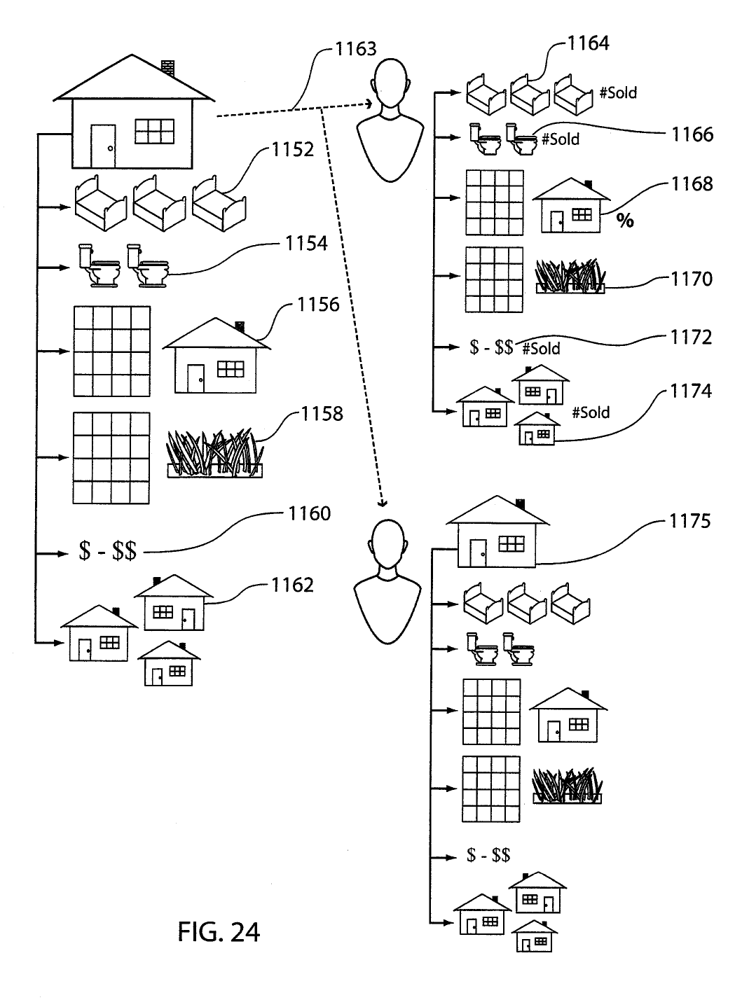

Turning now to FIG. 24, a diagram of professional experience to search term ranking subsystem 1130 is shown. A typical agent profile may include years of experience, number of lawsuits pending or resolved, negative or average user reviews, average fees, locations of service, number of clients serviced, office location, licenses/certificates active or inactive, education, and active insurances. The agent to home buyer/seller system, also known as a professional experience to search term ranking subsystem 1130, may be called a result matching system.

Using search terms, area of expertise data 1150 is extracted by term-experience matching subsystem 1100 that was entered by the user 1012 (FIG. 22). These may include, the size and characteristics of homes sold based on bedrooms, bathroom, overall size, lot size cost, neighborhood, etc. Each extracted area of expertise 1152, 1154, 1156, 1158, 1160 and 1162 is compared with the stable of homes sold by the agent. The advantage of the matching system is that the agent's experience is matched to the home characteristics. An agent that normally sells million dollar homes may be inexperienced in selling starter homes because the needs, desires and trade-offs are different. Likewise, an agent well versed in selling single family homes, may have little experience with condominiums and the like. Thus, in accordance with the present invention, it is desirable to improve the match between the customer's needs and the experience of the agent who will be working with the customers.

In one embodiment, the number of bedrooms 1152, bathrooms 1154, square footage 1156, lot size 1158, price range 1160, and/or building type or neighborhood 1162 sought by the searcher 1012 are compared 1163 against the number of homes sold by the agent with similar bedrooms 1164, bathrooms 1166, square footage 1168, lot size 1170, price range 1172 and/or number of homes/condominiums (etc.) sold at or near the neighborhood desired 1174. This is referred to herein as an agent experience match system (or sometimes as a professional experience match system).

In an alternate embodiment, each home purchased or sold by the agent 1175 is rated on the home data 1150 provided by the customer. Each agent home rating is then aggregated to form a match rating. This is referred to herein as an agent home match system.

Each of the agent home criteria may be weighted such that inexact matches contribute a partial rating, such as a two bathroom house contributing a partial rating to a desired one and one half bathroom house, because of the close proximity to the desired result. These rating weights may be based on a selected importance by the customer or pre-set by the result matching system.

Further, static data may also be included in the result matching system. For example, it has been noted that there is likely a correlation between response time to a customer request and a positive real estate outcome. Therefore, an agent may also be rated on his or her responsiveness to the customer.

These static data points may be pre-compiled and stored along with the agent's other static data, such as contact information. When the result matching system is requested by a customer, a portion of the agent rating may depend on such static data, but the rating overall is dynamic, based on the areas of expertise extracted.

In one embodiment, outcomes are monitored for agents and/or customers. For a seller, a larger than expected price (per square foot or other home characteristics), properties they have closed as seller or buyer, if a re-list occurred, property price fluctuations over time compared with the local, state and national markets and the amount of time on the market may be noted and stored as part of the agent's history with that sale. For a buyer's agent, similar statistics may be gathered and stored evidencing such characteristics as a lower than expected purchase price, quick closing or other desirable concessions. If no transaction is forthcoming, a failure may also be stored. Customer performance metrics may be monitored and scored as well. Negative reviews decrease match score, while positive reviews and frequent closing will increase match score. These data points may be internally or externally gathered. Thus, the particular success of the agent may be dependent on performance of each real estate deal.

In another embodiment, the agent's history or “track record” is overlaid on a baseline or “hyper-local comparable market average” to evaluate the effectiveness of a realtor. For example, the price per square foot of the properties in each transaction that a realtor represented is compared with the geographically immediate comparable sales price per square foot (in last 6 months). The sale price versus listing price (“spread”) is evaluated relative to the same population and days on market (“DOM”). The system also evaluates whether the agent represented the buy or sell side compared with the current home characteristics request. The results of the comparisons are then aggregated such that a value may be given to agent's history relative to the current home characteristics request.

For example, a buy side performance measure may compare a $212 price per square foot versus an average market of $289 per square foot and give a positive match rating of +40 points. A seven percent list versus sell spread compared with a four percent average may give a match rating of +10 points. These points are then aggregated in a total match rating for the agent compared with the house characteristics.

In another example, a sell side performance may compare 52 DOM versus an average of 92 DOM in the market and give +20 points match rating. A $252 price per square foot received versus a market average of $221 per square foot market average may give +50 points match rating. These points are then aggregated in a total match rating for the agent compared with the house characteristics.

In one embodiment the match ratings are normalized such that the top match point value is given a rating of 99%. This communicates that the result matching system believes the match to be the best agent for the job, but that there may be uncertainties.

External data sources may be monitored and mined. These data sources may be from private or public bodies. The result matching system may connect to external systems such as Multiple Listing Services (MLS) or information brokerages. The result matching system may also connect to public data sources as well, including government sources, such as tax data, title data or even agent discipline data. These sources can then be used in the matching algorithm. For instance, an agent that turns up disciplinary violations may rank lower than a similar agent without those violations.

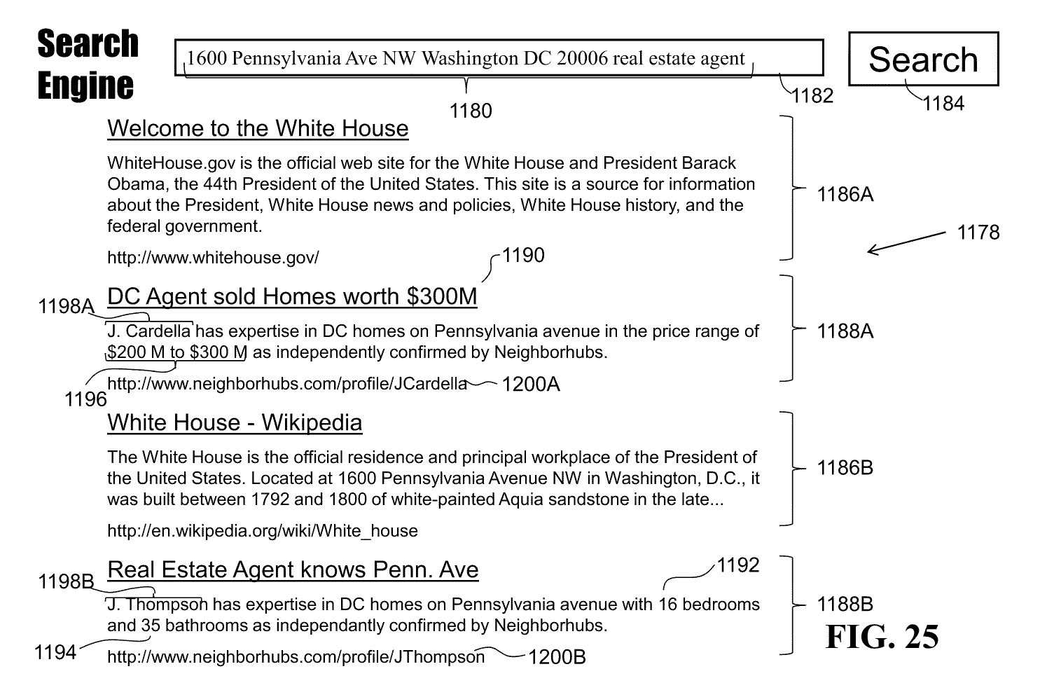

Turning now to FIG. 25, a search engine result page (SERP) 1178 with organic experienced agent results is shown. A user 1012 (not shown) may type in search terms 1180 within a search box 1182 and initiate a search such as a click on activate a search button 1184. Resulting SERP 1178 may be shown in response to such request.

In one embodiment, the SERP may contain both standard results 1186A and 1186B in combination with expertise results 1188A and 1188B. All of the results are organic, meaning non-paid SERP results. The advantage is that the user is presented with both classical ranking documents with expertise based profiles to present relevant results based on the search terms entered.

More specifically, the term-experience matching subsystem and the result matching system recognized that 1600 Pennsylvania Ave in Washington D.C. has specific spotlights of an “estimated value of $300 Million” 190, “16 bedrooms” 192 and “35 bathrooms” 1194. The system may have been able to gather other facts that are implicit in the search such as the typical age of the residents of the neighborhood and family composition of the neighborhood residents. The result matching system may then compile and rank the agents according to their areas of expertise relative to the search terms. The SERP result for the agents may then contain descriptions relating to which area or areas of expertise were significant in their rating for the search terms. In this embodiment, the result matching system decided that J. Cardella's price range 1196 was significant, while J Thompson's experience in similar number of bedrooms and bathrooms were significant.

Having decided that the results were significant, the system then combines the expertise results 1188A and 1188B with standard results 1186A and 1186B. The result ordering is based off an overall relevance rating that compares a normalized expertise rating with classical result ratings. The expertise results use the agent profile information to compose expertise results 1188A and 1188B to appear as classical results 1186A and 1186B in the SERP. In one embodiment, it pulls the agent name 1198A and 1198B and agent profile link 1200A and 1200B. Because the SERP looks the same, the users are already familiar with its functionality, but are now given relevant results that may be more relevant than before.

These areas of expertise spotlighted in 1190, 1192, 1194 and 1196 are beneficial because they increase the confidence of the user in the relevance of the results. For instance, a user may be looking at a specific property for a number of different reasons. A user looking at a price range may be attracted to price range spotlight 1196. Another user may care about bedrooms and view bedroom spotlight 1192 as more relevant. Thus, in either case, the user is given information that may direct her to the desired information.

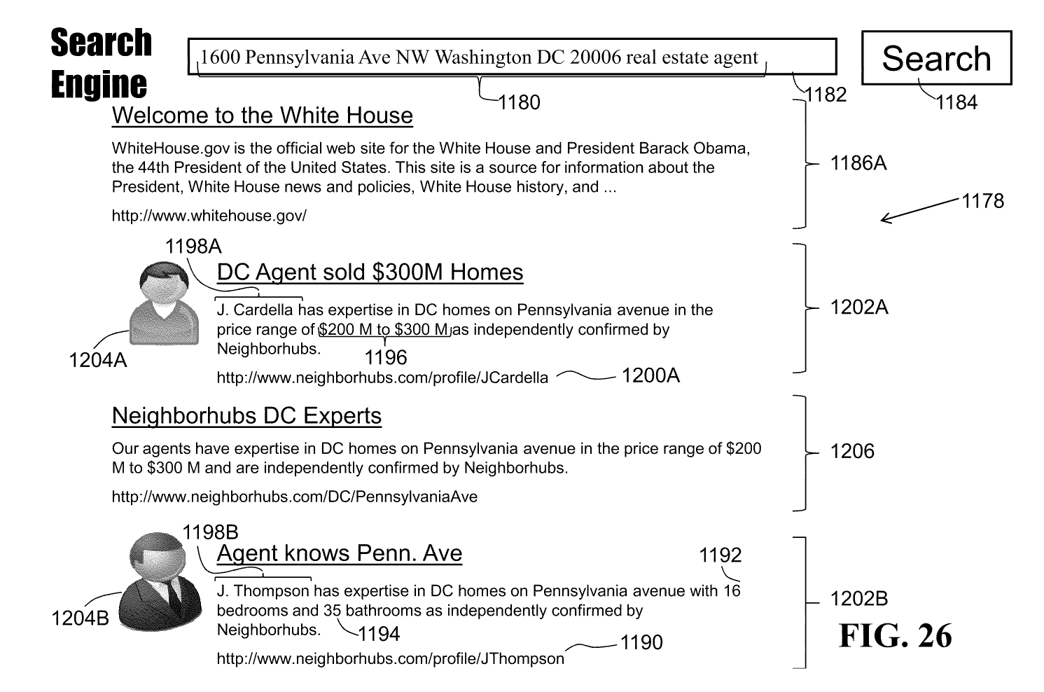

Turning now to FIG. 26, a search engine result page 1178 with profile enhanced organic experienced agent results 1202A and 1202B is shown. Expertise results may be further enhanced or differentiated from classical results by the addition of profile information. This profile information may include profile pictures 1204A and 1204B, certifications, areas of expertise, related areas to consider and other information available in the profile data. The profile information may stem from single data entries such as a profile link or be combinations of data entries such as an average house price or area of expertise.

The enhanced organic experienced agent results 1202A and 1202B may be enhanced with the same or similar information, or further differentiated by selecting to display different profile information. In one embodiment, the enhanced organic experienced agent results 1202A and 1202B are enhanced with similar information to have a consistent user experience and allow for direct comparison. In another embodiment, the enhanced organic experienced agent results 1202A and 1202B vary the information presented such that a user who may not find one result relevant may find relevant information in another result. For example, one person may not find the price range spotlight 1196 relevant (or of higher importance), but may find the bedroom spotlight 1192 and bathroom spotlight 194 relevant (or of higher importance).

Having expertise results does not mean that portions of the agent profile website will not receive classical result ranking. In fact, profile aggregation page 1206 may rank high in a classical ranking algorithm because it contains relevant information related to the search terms.

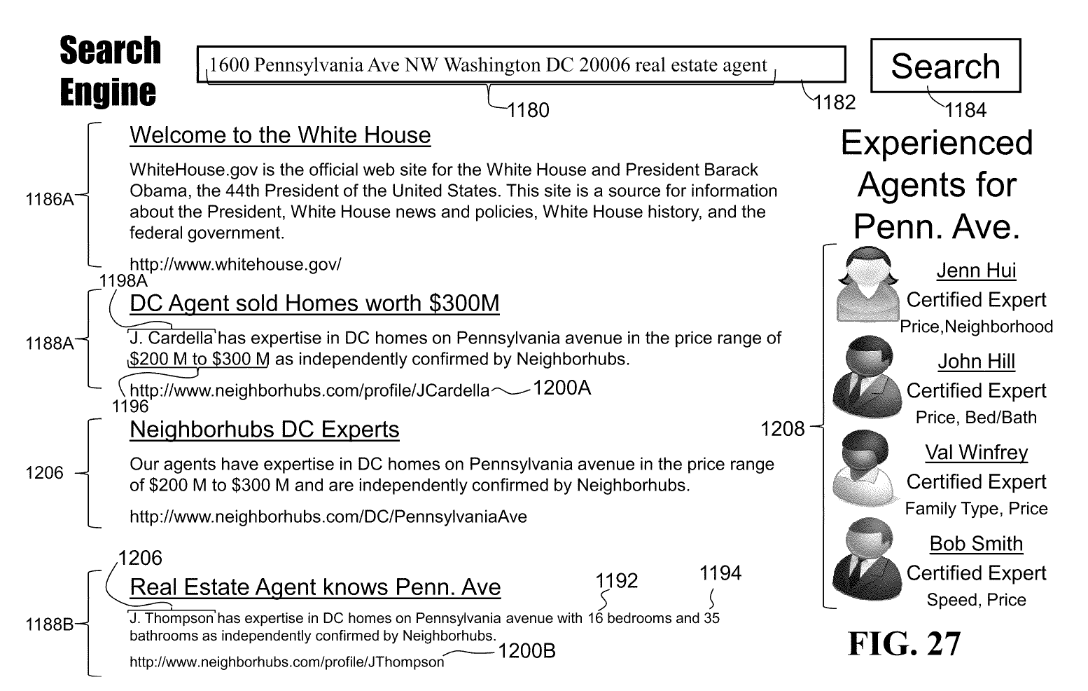

Turning now to FIG. 27, a search engine result page with organic experienced agent results and advertising that includes relevant certifications is shown. In addition to the organic results seen by 1186A, 1202A, 1206 and 1202B, search system 1010 (not shown) may also include a sidebar 1208. The sidebar 1208 may include advertising or further information for the user to consider.

The search system 1010 may show a sidebar 1208 populated with agent listings 1210A, 1210B, 1210C and 1210D. Agent listings 1210A, 1210B, 1210C and 1210D may be ranked or displayed based on factors that may include their relevance to the search terms. The listings may include profile information, including names of agents 1212A, 1212B, 1212C and 1212D. The profile may further be enhanced by certifications, which may include certifications of areas of expertise 1214A, 1214B, 1214C and 1214D by the professional experience matching subsystem or information management subsystem.

The certifications may be from individual certifications or aggregate certifications. For example, an agent who has certifications such as experience in a price range, typical customer ages and FHA loans may show the aggregate certification in “First Time Homebuyers” to a customer who may be searching relevant houses to a “First Time Homebuyer.” However, to a customer that is not in the age nor price range, but has searched on terms relevant to FHA loans, the agent profile may display the individual certification of “FHA Experienced” in the place of “First Time Homebuyer.”

Agent listings 1210A, 1210B, 1210C and 1210D may be selected for display in the sidebar based on a separate ranking system for the organic results. In one embodiment, the sidebar 1208 comprises paid advertisements. The payment and relevance may then be used to decide if the agent listings 1210A, 1210B, 1210C and 1210D will show in the sidebar 1208.

In another embodiment, the agent listings 1210A, 1210B, 1210C and 1210D are supplemental results that are selected for sidebar display. These results may or may not have been included in the organic results. These results may include a diverse selection of certifications or other information presented by the professional experience matching subsystem.

In fact, the sidebar may be used in cases where the search engine does not include agent results within the organic results because the results did not rank high enough or the search engine has not included agent results within the organic results. The sidebar may therefore add useful information to current search engines, without much change to their current system.

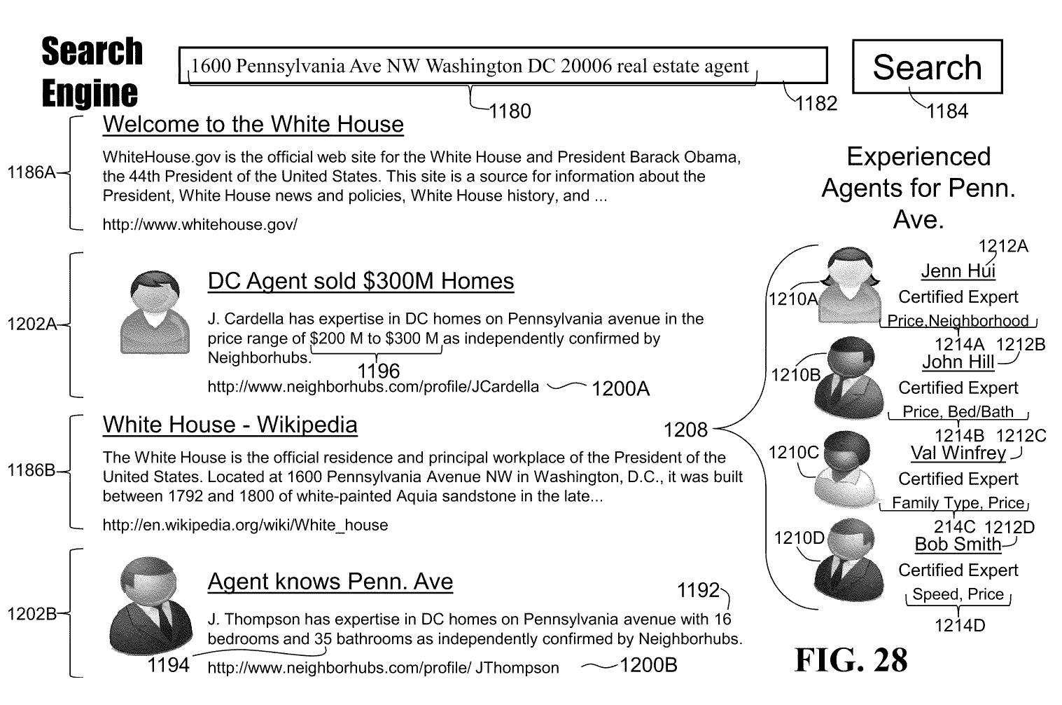

Turning now to FIG. 28, a search engine result page with profile enhanced organic experienced agent results and advertising that includes relevant certifications is shown. In one embodiment enhanced organic experienced agent results 1202A and 1202B are used in conjunction with the sidebar 1208.

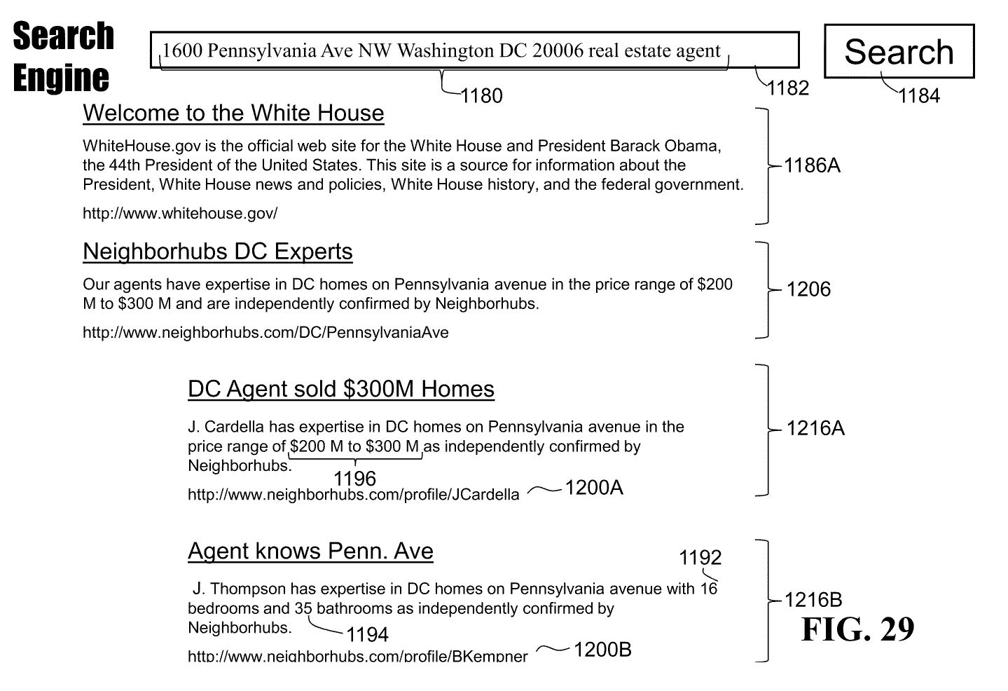

Turning now to FIG. 29, a search engine result page with agent results as supplemental to the organic result for the domain is shown. Instead of being shown as their own result, agent result 1216A and 1216B may be shown as supplements to the organic result of a classically ranked page such as profile aggregation page 1206. These supplemental results preserve the classical ranking algorithm of the search engine because they attach to the rank of their parent result, but provide useful results to the user based on their search terms.

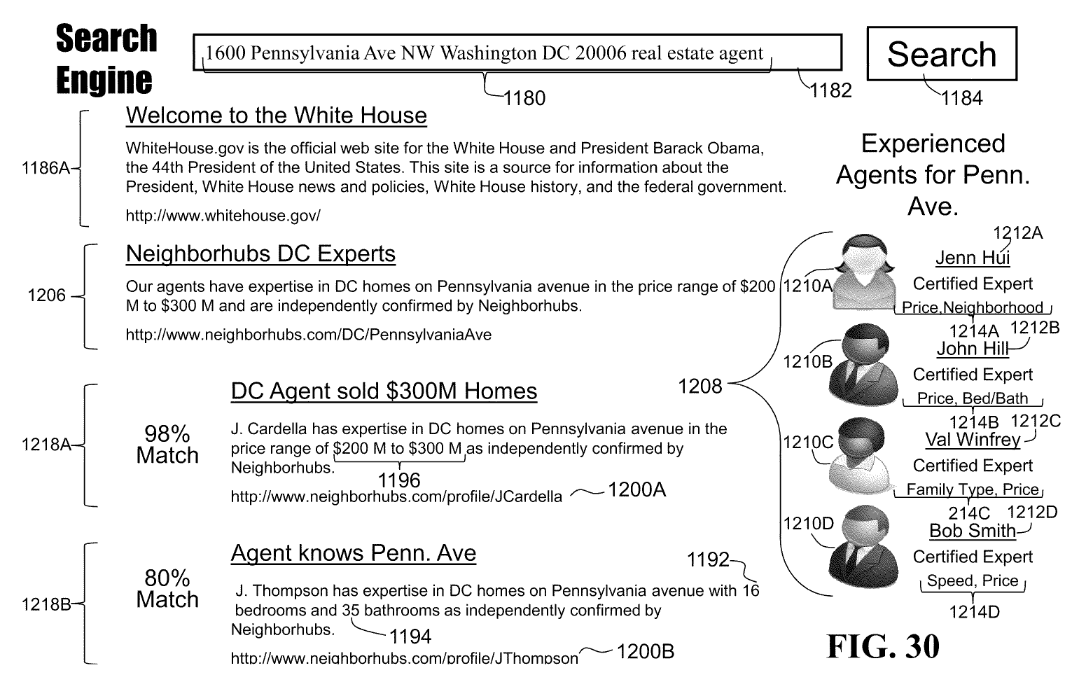

Turning now to FIG. 30, a search engine result page with profile enhanced agent results as supplemental to the organic result for the domain with advertising that includes relevant certifications is shown. The system may combine enhanced supplemental agent listings 1218A and 1218B with a sidebar 1208 and other features previously discussed.

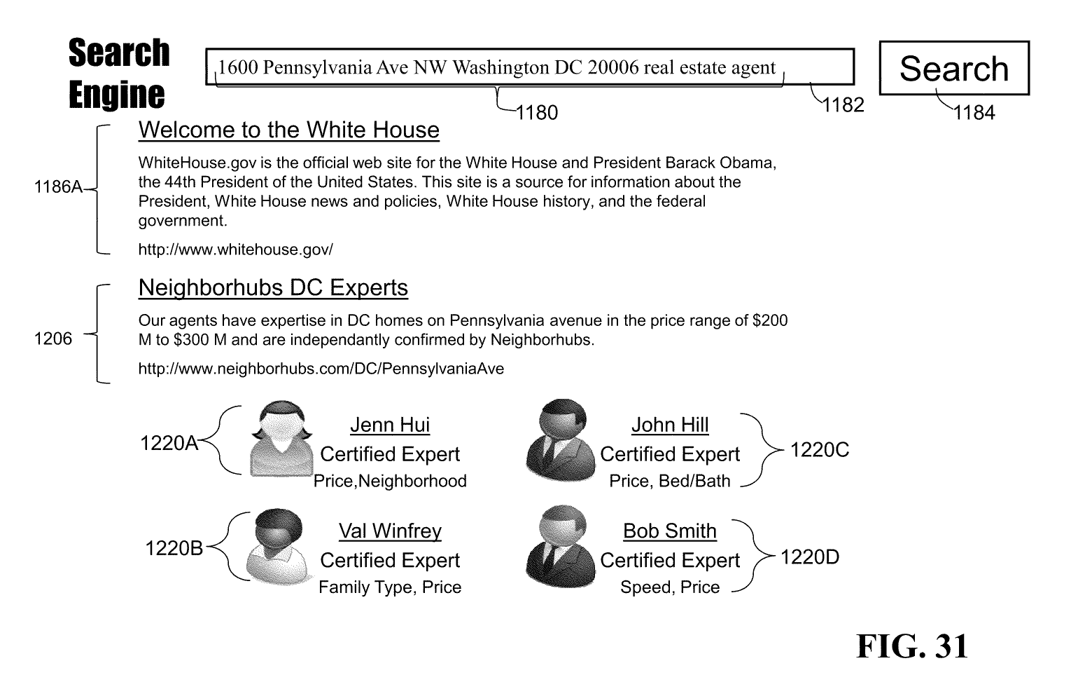

Turning now to FIG. 31, a search engine result page with certified agent results as supplemental to the organic result for the domain is shown. Supplemental results may have different formats, which may include information available from the profile data or information subsystem. These formats may be altered to suit the search engine style. In one embodiment, the supplement results may be supplemental certified results 1220A, 1220B, 1220C and 1220D which include profile pictures, names and links to the profile pages.

A website search with certified agent results related to the search and website may also be prepared. Searches may also be based on contextual information. In one embodiment, a user performs a search on a brokerage website. In addition to classical results, the system may use the contextual information to return certified agent results relating to the context of the website, or in this case, agents within the brokerage. In one embodiment, these results are placed under an organic listing for the agent rating service result 1228. The results may contain certifications relating to the context of the website.

The context may be predetermined from an aggregate search of the website or from a view of the current search page. In one embodiment, the search code is sent information about the website to give the search engine context. The information may be contained in an invisible box in the search form or even part of a JavaScript code.

Turning now to FIG. 32, a diagram of data collection server and its connection to other content servers is shown. Search system 1010 may comprise an information management subsystem 1232 with a data collection server 1234 connected to information storage 1236. The data collection server may query database server 1238 to collect information from its various databases 1240A and 1240B. The data collection server may also request documents 1242 from document server 1244. The requests and transmissions may be serviced by a network including the internet 1018.

The documents 1242 and databases 1240A and 1240B may be public or private, paid or unpaid information. By aggregating the data, information management subsystem 1232 may provide agent data and statistics for the rating of agents.

While multiple servers and subsystems have been mentioned, it should be understood that the servers and subsystems may reside on a single machine or a single server or subsystem may span multiple machines.

While the focus of the discussion has been on residential real-estate, it should be appreciated that commercial real estate or other forms of real estate agent matching would be similar. While specific data fields may be different, the desired fields may be compared against the agent's past real estate transaction fields to prepare a valuation of that agent.

There is thus disclosed an improved system for matching property characteristics or desired property characteristics to real estate agent experience. It will be appreciated that numerous changes may be made to the present invention without departing from the scope of the claims.

What is claimed is:

1. An agent matching system comprising:
an information management subsystem executing on one or more servers and configured for gathering and storing information regarding a plurality of real estate agents' closings, and further configured to dynamically calculate a match rating of the plurality of real estate agents based on submitted property characteristics; and
a customer subsystem executing on one or more servers and configured for receiving submitted property characteristics from a customer, further configured to receive one or more real estate agent match results from the information management subsystem, and further configured to deliver the results to a client computer.

2. The agent matching system of claim 1, wherein the information management subsystem comprises a database having stored information regarding the plurality of real estate agents' closings, wherein the information includes information as to multiple characteristics of houses sold by each agent.

3. The agent matching system of claim 2, wherein the stored information includes the number of bedrooms in each property sold by each of the plurality of agents.

4. The agent matching system of claim 2, wherein the stored information includes the number of bathrooms in each property sold by each of the plurality of agents.

5. The agent matching system of claim 2, wherein the stored information includes the house size in each property sold by each of the plurality of agents.

6. The agent matching system of claim 2, wherein the stored information includes the lot size in each property sold by each of the plurality of agents.

7. The agent matching system of claim 2, wherein the stored information includes the price range for each property sold by each of the plurality of agents.

8. The agent matching system of claim 2, wherein the stored information includes the location of each property sold by each of the plurality of agents.

9. The agent matching system of claim 2, wherein the stored information includes a comparison of the actual sales price to an expected sales price for each property sold by each of the plurality of agents.

10. The agent matching system of claim 2, wherein the stored information includes information selected from at least one of the group consisting of: agent's state license status, number of past complaints with a state department, number of active complaints with a state board, number of active complaints with a Better Business Bureau, publicly available third party ratings, private third party ratings, third party reviews, internal ratings, internal reviews, office location, and MLS membership status.

11. The agent matching system of claim 2, wherein the stored information includes information selected from at least one of the group consisting of: average number of submitted offers internally tracked, number of repeat customers, percentage of repeat customers, number of properties an agent owns, type of properties an agent owns, location of properties an agent owns, languages spoken, total number of active listings, total number of referred customers, number of open houses conducted, number of property photos published, level of detail of property description submissions, and quality of property marketing materials.

12. The agent matching system of claim 2, wherein the stored information includes information selected from at least one of the group consisting of: buyer's agent history, seller's agent history, number of homes sold for buy side of the transaction, number of homes sold for sell side of the transaction, number of buyers represented during a given timeframe, number of sellers represented, and location of active listings.

13. The agent matching system of claim 2, wherein the stored information includes information selected from at least one of the group consisting of: number of active listings weighted by similarity to submitted property, number of sales represented on buy side weighted by similarity to submitted property, number of sales represented on sales side weighted by similarity to submitted property, and location of sold homes.

14. The agent matching system of claim 2, wherein the stored information includes information selected from at least one of the group consisting of: price per square foot relative to comps, days on market relative to comps, difference between ask versus sales price, number of inactive listings similar to submitted property, number of inactive listings similar to submitted property, location of inactive listings, ratio of properties sold versus listed, number of price drops for each property listed, and number of price drops for each property sold.

15. The agent matching system of claim 2, wherein the stored information includes information selected from at least one of the group consisting of a number of homes sold during last 180 days, number of homes sold during last 1 year, number of homes sold during last 2 years, length of time as member of the MLS, and length of time actively listing properties near the submitted property.

16. The agent matching system of claim 1, wherein the customer subsystem is further configured to receive home characteristics from a buyer's search for home listings and return real estate agent match results from the information management subsystem.

17. The agent matching system of claim 10, wherein the customer subsystem is further configured to display at least a portion of the real estate agent match results along with the home listings.

18. The agent matching system of claim 11, wherein at least a portion of the real estate agent match results are located in a sidebar.

19. The agent matching system of claim 11, wherein at least a portion of the real estate agent match results are located in a grouping on a webpage.

20. The agent matching system of claim 1, further comprising a lead management subsystem is configured to associate customers with real estate agents.

21. The agent matching system of claim 14, wherein the lead management subsystem is further configured to prioritize the association between customers with real estate agents based at least in part on the match rating.

22. The agent matching system of claim 14, wherein the lead management subsystem is further configured to distribute customers to real estate agents based at least in part on the match rating.

23. The agent matching system of claim 16, wherein the lead management subsystem is further configured to monitor the status of the customer and redistribute the customer to the next highest match rating for a real estate agent if the status of the customer is below a threshold.

24. The agent matching system of claim 1, wherein the information management subsystem is configured to receive data about real estate agents from third party information sources.

25. The agent matching system of claim 24 wherein the third party information sources include Multiple Listing Systems.

26. The agent matching system of claim 24 wherein the third party information sources include publicly available web pages and private data sets.

27. The agent matching system of claim 24 wherein the third party information sources include government information sources.

28. The agent matching system of claim 27 wherein the government information sources is selected from the group consisting of agent discipline data, tax data, and title data.

29. A method of matching agents and customers comprising:
providing a web service system for communication with remote interfaces, the system comprising at least one server;
compiling a history of a plurality of agents based on property characteristics for each of a plurality of closings for each of the plurality of agents;
comparing each of a set of customer property characteristics with one or more corresponding characteristics from each of the plurality of agents' closings;
assigning a value to the result of the comparing step;
compiling an overall match value from the values from the assigning step for each of the plurality of agents; and
communicating over the web service system one or more one or more agents whose overall match value most closely corresponds with the set of customer property characteristics relevant to a customer.

30. The method according to claim 29, wherein the service system is provided over the web.

31. The method according to claim 29, wherein the property characteristics comprises number of bedrooms in the property.

32. The method according to claim 29, wherein the property characteristics comprises number of bathrooms in the property.

33. The method according to claim 29, wherein the property characteristics comprises size of the property.

34. The method according to claim 29, wherein the property characteristics comprises location of the property.

35. The method according to claim 29, wherein the property characteristics comprises sales price of the property.

36. The method according to claim 29, wherein the overall match value is computed by aggregating individual property characteristics into subvalues and then aggregating the subvalues into the overall match rating.

37. The method according to claim 29, wherein each of the properties is assigned a value dependent on the correlation of the desired property characteristics and then aggregating the overall value by combining the value of each property.

38. The method according to claim 29 further comprising the step of receiving a set of customer property characteristics from a customer.

39. The method according to claim 38 wherein the step of receiving a set of customer property characteristics from a customer further comprises retrieving the set of customer property characteristics from a home search performed by a customer.

40. The method according to claim 39 further comprising the step of displaying at least a portion of the corresponding agents along with a set of results from the home search.

41. The method according to claim 40 wherein the displaying step further comprises displaying the portion of the corresponding agents in a sidebar on a webpage.

42. The method according to claim 29, wherein the communicating step requests a response from the agent to the customer.

43. The method according to claim 42 further comprising the steps of:
monitoring a relationship between the agent and customer; and
communicating with the customer if the relationship grows too stale.

44. An agent matching system comprising:
an information management subsystem executing on one or more servers and configured for gathering and storing information regarding a plurality of real estate agents' closings, and further configured to dynamically calculate one or more areas of expertise for a selected plurality of real estate agents; and
a profile subsystem executing on one or more servers and configured retrieving one or more agent areas of expertise derived from information in the information management subsystem, and further configured to deliver the areas of expertise to a client computer.

45. The method according to claim 44, wherein an area of expertise is selected from the group of price range, neighborhood, family size, customer age, home square footage, type of home and use.

46. The method according to claim 44, wherein one or more of the areas of expertise is an individual area of expertise.

47. The method according to claim 44, wherein one or more of the areas of expertise is an aggregate of multiple areas of expertise.

48. An agent matching system comprising:
a database of agent information, further comprising agent profiles and closing data;
a webpage providing a real estate search and receiving search information;
an agent matching module receiving search information from the webpage and correlating the search information with the database information to output one or more relevant agent profiles for display on the webpage.

49. The agent matching system of claim 48, wherein the search information comprises desired home characteristics.

50. The agent matching system of claim 49, wherein agent matching module further outputs a rank of the agent profiles according the home characteristics correlation with agent closing data.

51. The agent matching system of claim 50, wherein the agent profiles rank is supplemented with static agent data.

52. A method for matching a real-estate professional to home characteristics comprising:
compiling a plurality of closings within a geographic area;
creating a plurality of real-estate professional profiles;
associating at least some of the closings with at least one real-estate professional profile;
receiving a search request that includes home characteristics;
comparing the home characteristics to at least one of the plurality of the closings to result in a rating value;
aggregating the rating values of the plurality of closings associated with one of the real-estate professional profiles and computing a profile ranking based on the aggregated ranking values; and
returning at least one of the real-estate professional profiles with a corresponding profile ranking.

53. A search system comprising:
an information management subsystem executing on one or more servers and configured for gathering and storing information regarding a plurality of professional results, and further configured to associate the plurality of professional results with a plurality of professional profiles;
a term-experience matching subsystem executing on one or more servers and configured to break the search terms into term units and match term units to areas of expertise; and
a professional profile server configured to match the areas of expertise to relevant professional profiles from the plurality of professional profiles and rank the relevant professional profiles using data from the information management subsystem.

54. The search system of claim 53, further comprising:
a classical results server configured to return classical results;
a results server configured to rank the classical results and professional profiles together and return a search engine result page.

55. A method of matching search terms to experienced professionals:
compiling a history of a plurality of professional experience characteristics for each of a plurality of results for a plurality of professionals;
receiving a set of search terms;
compiling a set of areas of expertise from the search terms;
compiling a set of experienced professionals relevant to the areas of expertise based at least in part on the plurality of results; and
ranking the set of experienced professionals according to the areas of expertise; and
presenting the results.

56. The method according to claim 55, wherein the search terms include contextual information.

57. The method according to claim 55, wherein the ranking further comprises weighting the ranking by any modifiers discovered in the search terms.

58. A professional experience matching system comprising:
an information management subsystem executing on one or more servers and configured for gathering and storing information regarding a plurality of results of service of a plurality of professionals, and further configured to calculate one or more areas of expertise for the plurality of professionals; and
a term-experience matching subsystem executing on one or more servers and configured to break the search terms into term units and match term units to areas of expertise.

59. A real-estate professional experience matching system comprising:
a database of a plurality of closings;
a database of a plurality of real-estate professional profiles, the profiles associated with zero or more of the plurality of closings;
a search server providing a search interface to receive search information and output real-estate characteristics; and
a matching server receiving the real-estate characteristics, matching the real-estate characteristics to closings and outputting a set of profiles, the set of profiles comprising the plurality of real-estate professional profiles that are associated with matched closings.

60. A method for selecting a real estate agent, the method comprising:
selecting a database having a plurality of real estate agent profiles including sales experience of the real estate agents;
imputing a plurality of property characteristics; and
generating a list of real estate agents based on the relevance of the real estate agent profiles to the property characteristics.

61. The method of claim 60, wherein the method further comprises allowing a customer to
select which real estate agents on the list he or she wishes to receive bids from.

62. The method of claim 61, wherein the method further comprises notifying the real estate
agents who are selected of their opportunity to bid on representing the customer.

63. The method of claim 60, wherein the real estate agents on the list are provided with a
score based on relevancy to the property characteristics entered.

64. The method of claim 60, wherein the method comprises pairing a customer with a real
estate agent on the list and monitoring the outcome of the representation and adjusting the a rating of the real estate agent based on the outcome.

65. The method according to claim 60, wherein the method comprises paying a customer
upon the completion of a real estate transaction handled by a real estate agent selected from the list of real estate agents.
